(19) United States
(12) Patent Application Publication
(10) Pub. No.: US 2024/0199175 A1
(43) Pub. Date: Jun. 20, 2024

(54) A WATERCRAFT, AND AN ALIGNMENT STRUCTURE FOR AN ELECTRICALLY POWERED WATERCRAFT

(71) Applicant: Ride Awake AB, Stockholm (SE)

(72) Inventors: Mathias Bergman Werntoft, HÖLLVIKEN (SE); Philip Sveningsson, HÖLLVIKEN (SE); Martin Pråme Malmqvist, SVEDALA (SE); Jonas Blanking, Malmö (SE)

(73) Assignee: Ride Awake AB, Stockholm (SE)

(21) Appl. No.: 18/554,698

(22) PCT Filed: Apr. 12, 2022
(86) PCT No.: PCT/EP2022/059760

§ 371 Date: Oct. 10, 2023

(30) Foreign Application Priority Data
Apr. 12, 2021 (SE) 2150448-5

(51) Int. Cl. B63B 32/10; B63B 32/50; H01M 50/249; H01M 50/289

(52) U.S. Cl. CPC B63B 32/10; B63B 32/50; H01M 50/249; H01M 50/289; H01M 2220/20

(57) ABSTRACT

An alignment structure for a battery pack and a propulsion module for a powered watercraft. The alignment structure is configured to be received in and affixed to a powered watercraft. The alignment structure includes a first alignment feature configured to receive a removable battery pack and a second alignment feature configured to receive a removable propulsion module for propelling the powered watercraft in a longitudinal direction. The alignment structure extends along the longitudinal direction to provide a space for receiving the battery pack and/or the propulsion module. The first alignment feature and the second alignment feature are together configured for positioning and fixedly locating a battery pack and a propulsion module relative to each other so that the battery pack and the propulsion module having been received in the alignment structure are individually removable.

### TECHNICAL FIELD

The invention relates to an alignment structure to be received in and affixed to a powered watercraft, the alignment structure being configured to removably receive a battery pack and a propulsion module for propelling the powered watercraft.

### BACKGROUND

Personal watercrafts are a popular type of motorized leisure-craft for water which are designed to be small, fast, easily maneuverable, affordable and safe to operate due to having propulsion systems without external propellers, which makes them safer to operate around swimmers and wildlife compared to small motorboats.

In recent times, motorized surfboards, and in particular a type of water-jet propelled surfboard typically referred to as a “jetboard”, has gained much popularity for leisure activity as a light and more nimble alternative to conventional jetski type watercrafts. Improvements in battery technology has furthermore allowed use of silent electrical propulsion means to replace noisy internal combustion engines previously used.

It is generally known to provide an electrically powered watercraft, such as a waterjet propelled surfboard, with an electrical battery pack which is removably attached to a main body of a surfboard. This may allow exchange of a depleted battery pack with a fully charged battery pack and reducing the weight the end user has to carry at the water line by allowing the battery pack to be carried separately. However, to avoid exposing the terminals of large-capacity replaceable battery to salt water due to misalignment of the replaceable battery pack within a battery compartment of the electric jetboard, either due to improper fitment or structural damage, care must be taken to design a replaceable battery system which is safe and reliable.

It is furthermore known to provide detachable propulsion means to propel a powered watercraft e.g. by means of an electrical motor coupled to a power conversion circuit for receiving power from a battery and configured to drive an impeller for a water jet. To avoid short circuits from salt water ingress, such a propulsion module is generally provided in a water-tight housing. Various solutions exist for detachably connecting an electrical propulsion module, such as a jet drive, to a main body of a surfboard, e.g. such as the hull of a jetboard, in order to provide good mechanical stability and to allow safe insertion/removal by disengaging electrical connections to batteries.

However there exists a need for an improved electrically powered water-jet propulsion system improving the existing solutions.

### SUMMARY

Disclosed herein is, in a first aspect of the invention, a watercraft, in particular a surfboard, comprising:
a flotation body having a top face providing a surface for a user to stand on when using the watercraft, an opposite bottom face, a front end, a rear end, a cavity opening up at the top face and a recess opening up at the bottom face, the recess extending from the rear end to the cavity along a part of the length of the watercraft,
a housing, also referred to herein as an alignment structure, connected to the flotation body, the housing comprising a first housing part connected to a second housing part,
   the first housing part, also referred to herein as a first alignment part, being positioned in the cavity and being upwardly open for receiving a battery pack at the top face,
      the battery pack being for powering a propulsion unit for propulsion of the watercraft,
   the second housing part, also referred to herein as a second alignment part, being positioned in the recess and defining a downwardly and rearwardly open elongated channel of the watercraft,
the channel extending along a part of the length of the watercraft and configured for receiving the propulsion module by moving the propulsion module into and along the channel at and from the rear end, into an operative position wherein the propulsion module may be powered by the battery pack for propulsion of the watercraft.

Preferably, the second housing part has a top face that defines a surface for a user to stand on when using the watercraft, in that no portion of the flotation body extends above the second housing part, wherein the top face of the second housing part is contiguous or essentially contiguous with the top face of the flotation body to provide a contiguous standing surface for the user defined by the top face of the flotation body, the top face of the second housing part and the top face of the battery pack.

Preferable, the channel has tracks and/or ribs along its length, which tracks and/or ribs are complementary with tracks and/or ribs along the length of the propulsion module, for supporting the propulsion module in its operative position.

Preferably, a lock is provided for locking the propulsion module in the operative position, i.e. to prevent it from inadvertently moving out of the channel at the rear end.

Preferably, the flotation body is molded around parts of the housing to establish a permanent connection between the flotation body and the housing.

In a preferred embodiment the first housing part is integrally connected with the second housing part, preferably by the housing being an integrally molded single-piece structure, preferably of a plastic material. Preferably, an opening between the first housing part and the second housing part permits an electrical contact of the propulsion module to engage an electrical contact of the battery pack when the battery pack is placed in the cavity when the propulsion module has been positioned in the operative position, which positioning preferably is carried out at the factory.

Disclosed herein is, in a second aspect of the present disclosure, an alignment structure for a battery pack and a propulsion module, such as an electrical propulsion module, for a powered watercraft, such as a jetboard. The alignment structure is configured to be received in and affixed to, such as rigidly affixed to, said powered watercraft, the alignment structure comprising a first alignment feature configured to receive a removable battery pack, and a second alignment feature configured to receive a removable propulsion module for propelling the powered watercraft in a longitudinal direction. The alignment structure may be configured to extend along the longitudinal direction, and may be configured to provide a space for the battery pack and/or a space for the propulsion module. The first alignment feature and the second alignment feature are configured for positioning and fixedly locating said battery pack and said propulsion module relative to each other. Thereby, said battery pack and said propulsion module may be individually removable.

It is an advantage of the alignment structure as herein described that the alignment structure may facilitate more accurate aligning and securing of a battery pack and/or a propulsion module within a floatation body, such as in a hull or a substantially rigid main body of a jetboard, such as in a cavity of a floatation body, such as in a hull or a main body. Hereby, the battery pack and propulsion module may be enabled to be installed to within strict tolerances in order to ensure good alignment and e.g. to fit a contacting portion of a propulsion module with a corresponding contacting portion provided as part of a battery pack without the need for the floatation body, such as the hull or main body to be manufactured using similar strict tolerances. Thus, the alignment structure provides that the hull or main body may be manufactured with more relaxed tolerances while ensuring accurate positioning and alignment of the removable battery pack and/or the removable propulsion module.

Hereby, it is contemplated that production costs of commercially available jetboards may be reduced because the battery compartments and support structures provided for the battery and propulsion means may be easily manufactured or installed.

It is an advantage of the alignment structure that the mechanical interface between the alignment structure and the hull or main body of the jetboard may be a robust interface, not being susceptible to tight tolerances, while the interface between the alignment structure and the battery pack and/or the propulsion module may be an interface requiring a larger degree of precision. As typically the alignment structure is manufactured of a rigid material, being easy to precision manufacture, while the hull or main body of the jetboard board is typically shaped or remanufactured using a low precision process in softer materials, the alignment structure may provide the needed alignment between the battery pack and the propulsion module.

For example, surfboard shapers may wish to manufacture parts of a hull or substantially rigid main body for an electrical jetboard using low-precision surfboard manufacturing or free-hand shaping techniques to shape a floatation body, such as surfboard blank made from foam or composite materials, into a desired shape. The alignment structure provides a simple solution to alignment problems that may arise when manufacturing an electrically powered water-jet propelled surfboard e.g. due to requiring the battery to be easily removable or swapped out in wet conditions.

The alignment structure is a structural part or assembly for a battery pack and a propulsion module for a battery powered watercraft, such as an electrical jetboard. The inventors have realized that it is desirable to provide an electrical jetboard with a wholly replaceable water-jet propulsion module powered by a replaceable battery arranged within a battery compartment of the jetboard and detachably connected to said propulsion module, and that such a jetboard can be made cheaper to obtain for the consumer by providing an alignment structure to solve the alignment problem.

The alignment structure is configured to be received in and affixed to a powered watercraft, such as a personal watercraft, such as a jetboard, a jetski, etc. and may have a substantially fixed nozzle and rely on the rider to stand up and lean into turns, for example by shifting the center of mass and steering using fins underneath the jetboard, i.e. without altering the direction of a water-jet relative to the jetboard.

For example, the powered watercraft may comprise a floatation body, such as a hull or a substantially rigid main body, which provides a cavity, such as an elongated cavity which extends in a longitudinal direction of the floatation body, and wherein the floatation body cavity has a geometrical shape that defines an internal volume so that the alignment structure may be received in said cavity, such as by extending longitudinally therein. The powered watercraft may comprise at least one structurally rigid portion, such as a hull or a substantially rigid main body, at or to which an alignment structure may be affixed in any known way, e.g. by use of affixing elements, such as an adhesive, such as connection elements, such as fiber-reinforced bonding materials, etc.

In some embodiments, the alignment structure is configured for aligning a battery pack for an electrical water-jet propelled surfboard, e.g. for powering a water-jet motor. The alignment structure is configured for receiving a removable battery pack, such that the removable battery pack is positioned and fixedly located relative to a hull or a substantially rigid main body of the surfboard when the battery pack is received in the alignment structure and the alignment structure is further received in and affixed to said hull or substantially rigid main body of the surfboard.

The alignment structure comprises a first alignment feature configured to receive a removable battery pack. The battery pack may be removably positioned in an upper compartment accessible from a upper surface of the powered watercraft by means of said battery pack being received by the first alignment feature. It is generally the case that a removable battery pack for a powered watercraft, such as an electrical jetboard, is provided in a water-tight or substantially water-tight housing comprising one or more rechargeable battery cells. The removable battery pack may comprise a battery management system (BMS) configured to provide power conversion and battery cell conditioning to the rechargeable battery cells in the battery pack. A pair of power terminals are typically provided at an exterior surface of the battery pack to enable recharging of its rechargeable battery cells and/or delivery of electrical power from said rechargeable battery cells to a load, such as an electrical motor, the propulsion module or the like. In this way, the removable battery pack may provide a contacting portion configured to engage with a compatible contacting portion of an external battery charger and/or an electrical device configured to receive electrical power from said battery pack, such as a compatible contacting portion provided at the propulsion module.

In some embodiments, the removable battery pack comprises a housing, one or more rechargeable battery cell connected to an electronic circuit and a contacting portion having a plurality of electrical contacts connected to said electronic circuit, wherein the electrical contacts are provided at an exterior surface of said housing. For example, the housing of the removable battery pack may form a water-tight or substantially water-tight housing which encloses at least the rechargeable battery cells and the electronic circuit. The housing may be made of a hard plastic material, such as acrylonitrile butadiene styrene (ABS), or a suitable thermoplastic polymer.

In this way, the removable battery pack may be provided with a rigid outer surface which the first alignment feature is configured to fit against e.g. by abutment.

The alignment structure may be an alignment structure for a removable battery pack to be received in a battery compartment of a powered watercraft, such as a jetboard. For example, the first alignment feature may have a geometrical shape and/or surface feature compatible with an outer surface of a battery pack, such as by forming a battery cradle configured to receive a substantial portion of the housing of a removable battery pack. The first alignment feature may include a first abutment surface configured to provide coplanar contact with an outer surface of a battery pack. Alternatively or additionally, the first alignment feature may be or form part of a fastening elements for securing a battery pack to the alignment structure.

In some embodiments, the first alignment feature is a battery alignment interface selected from a group consisting of a top-mounted guide-rail interface, a bottom-mounted guide-rail interface, a vertical guide-rail interface, a top-mounted frame interface, a bottom-mounted frame interface, a planar interface, a tray interface, a cradle interface or a compound three-dimensional shape interface. Also, the first alignment feature may be or include any combination of elements in this group.

In some embodiments, the first alignment feature provides a space for a removable battery pack to be received in when the alignment structure is received in and affixed to a powered watercraft, such as by forming an upper compartment in a floatation body, such as a hull or substantially rigid main body, of said powered watercraft. Thus, the first alignment feature may provide that a removable battery pack can be removably positioned and fixedly located with improved accuracy relative, at least, to the alignment structure.

The alignment structure comprises a second alignment feature configured to receive a removable propulsion module. The removable propulsion module is for propelling the powered watercraft in a longitudinal direction, such as in a forward direction of a surfboard, i.e. an electrical water-jet propelled surfboard. The removable propulsion module may comprise a drive, such as jet drive, the drive being configured to propel a watercraft by transforming rotational power delivered to a rotor into a linear thrust by said rotor acting upon a fluid. For example, the drive may be connected to a rotor in the form of a rotating hub having a plurality of radiating blades for acting on a fluid. The propulsion module may be configured to be removably positioned in a lower or rear compartment, preferably at least partially below the waterline of the powered watercraft. Typically, this is obtained by said propulsion module being received by the second alignment feature. The lower or rear compartment may be accessible from a lower or rear surface of the powered watercraft, respectively, or in a combination thereof. It is generally also the case that a removable propulsion module, such as a jet drive, for a powered watercraft, such as for an electrical jetboard, comprises an electrical motor, such as an electrical motor provided in a water-tight or substantially water-tight housing. The removable propulsion module may comprise a water inlet and a water outlet, such as a jet nozzle, being in fluid communication with said water inlet. The removable propulsion module may comprise an electrical motor, a motor controller, such as a pulse-width modulation (PWM) motor controller, and an impeller configured to act upon a fluid when driven by the electrical motor. An impeller for use in a water-jet is generally provided on a rotary hub to allow the impellers to spin, so that water acted upon by the impeller is accelerated to produce a water jet. The removable propulsion module may comprise an inlet duct configured to draw in water from a body of water into a tubular channel by the impeller being rotated via a shaft placed substantially concentrically with said tubular channel, thus providing thrust in a longitudinal direction by expelling water out through a nozzle. The propulsion module may comprise a fixed nozzle.

In some embodiments, the second alignment feature is a drive or propulsion module alignment interface selected from a group consisting of a top-mounted guide-rail interface, a bottom-mounted guide-rail interface, a vertical guide-rail interface, a top-mounted frame interface, a bottom-mounted frame interface, a planar interface, a tray interface, a channel interface or a compound three-dimensional shape interface. A compound three-dimensional shape interface may comprise a plurality of contact points distributedly provided at two or more three-dimensional shapes with complex geometries and interconnected with each other e.g. by truss structures. The second alignment feature may be or include any combination of elements in this group.

In some embodiments, the removable propulsion module comprises an electrically driven water-jet configured to propel the powered watercraft. The propulsion module may be provided with electrical power from the removable battery pack, e.g. by the propulsion module having a contacting portion with a plurality of electrical contacts configured to be electrically connected to a plurality of electrical contacts provided at a compatible contacting portion of the removable battery pack. In this way, a direct current (DC) electrical output from the battery pack may be provided to the electrical motor of the propulsion module, which may for example be a brushless DC motor or an induction motor powered by alternating current (AC) via a DC-to-AC converter.

The alignment structure may be an alignment structure for a removable propulsion module to be received in a drivetrain compartment of a powered watercraft, such as a jetboard. For example, the second alignment feature may have a geometrical shape and/or surface feature of the alignment structure compatible with an outer surface of a propulsion module, such as by forming a rear longitudinal channel configured to at least partially receive the removable propulsion module. For example, the propulsion module may have an elongated, rectangular or box-like shape, such as a substantially elongated, rectangular or box-like shape, which fits into such a channel, for example such that an underside of the propulsion module is positioned at or below the waterline when the powered watercraft is in use.

The second alignment feature may include a second abutment surface configured to provide coplanar contact with an outer surface of a propulsion module. Alternatively or additionally, the second alignment feature may be or form part of a fastening element or a detachable attachment element for securing a removable propulsion module to the alignment structure. The propulsion module may generally be removable by being detachably mountable, i.e. being removable as a whole.

In some embodiments, the removable battery pack is configured to be connected to the removable propulsion module, such as by being directly connected or electrically connectable to the removable propulsion module. The battery pack or the propulsion module may be provided with a detachable electrical connector, e.g. configured to directly connect one to the other, so that the removable propulsion module may be powered by electrical energy stored in the battery pack.

In some embodiments, the second alignment feature provides another space for receiving a removable propulsion module, preferably adjacent a space for receiving a removable battery pack, when the alignment structure is received in and affixed to a powered watercraft, such as for example by forming a lower or rear compartment in a floatation body, such as a hull or substantially rigid main body, of said powered watercraft. It may likewise be advantageous that the second alignment feature provides another space for receiving a removable propulsion module which is adjacent a space provided by the first alignment feature for receiving a removable battery pack as the battery pack and the propulsion module may then be provided in direct contact.

The second alignment feature may provide that a removable propulsion module can be removably positioned and fixedly located with improved accuracy relative to the alignment structure, and thus relative to a removable battery pack received at the first alignment feature and likewise removably positioned and fixedly located.

In some embodiments, the first alignment feature and the second alignment feature together provide a space for receiving a removable battery pack and a removable propulsion module, for example such that the battery pack and the propulsion module are provided adjacent one another, e.g. close enough for direct contact.

In some embodiments, the alignment structure extends along the longitudinal direction to provide a space for the battery pack and/or the propulsion module. The alignment structure extends in a longitudinal direction, which may be substantially identical to a direction of thrust generated by a propulsion module received at the second alignment feature, thereby being configured for propelling a powered watercraft in a longitudinal direction when the alignment structure is received in and affixed to said powered watercraft.

In some embodiments, the alignment structure extends along a longitudinal direction by spanning a longitudinal distance substantially greater than a longitudinal extent of the removable battery pack and/or the removable propulsion module when received in the alignment structure. Hereby, a substantial rigidity may be provided between a battery pack and a propulsion module when both are removably received at the first and second alignment features of the alignment structure. The longitudinal extent of a removable battery pack and/or a removable propulsion module is a distance which may be measured from an outermost surface of the removable battery pack and/or the removable propulsion module to an opposite outermost surface as seen along the longitudinal direction when removably received at the alignment structure. The longitudinal distance spanned by the alignment structure may similarly be measured along the longitudinal direction of the alignment structure.

In some embodiments, the alignment structure extends along a longitudinal direction by spanning a longitudinal distance substantially greater than a longitudinal extent of a propulsion unit comprising a removable battery pack and a removable propulsion module being positioned and fixedly located relative to each other by means of the first and second alignment features of the alignment structure.

In some embodiments, the alignment structure provides a space for the battery pack and the propulsion module. For example, the alignment structure may be received in and affixed to a cavity provided in a powered watercraft, such as a cavity provided in a floatation body, such as a hull or substantially rigid main body, of a jetboard, whereby a space for a battery pack and a propulsion module is provided substantially within the cavity.

In some embodiments, the alignment structure is configured to be received in and affixed to a cavity provided in said powered watercraft, such as in a floatation body, such as in a hull or a substantially rigid main body, of said powered watercraft, such as a surfboard hull. The cavity may be an elongated longitudinal cavity provided internally within a hull and extending from an opening at an upper surface of the hull to another opening at a lower or rear surface of the hull. By the alignment structure being received in such an elongated longitudinal cavity provided internally within a hull, the alignment may expose e.g. the first alignment feature at the opening at the upper surface of the hull and the second alignment feature at the another opening at the lower or rear surface of the hull. In this way, the alignment structure provides a space for the battery pack and/or the propulsion module by extending along the longitudinal direction and being configured to be received in and affixed to a cavity in a powered watercraft.

The first alignment feature is configured for positioning and fixedly locating a battery pack relative to the alignment structure so that the battery pack may be removable. Also, the second alignment feature is configured for positioning and fixedly locating a propulsion module relative to the alignment structure, e.g. in a similar way, so that the propulsion module may be removable. Hereby, an electrical propulsion system may be formed comprising an alignment structure, a removable battery pack and a removable propulsion module when the removable battery pack is received at the first alignment feature, in a mounted position, and the removable propulsion module is received at the second alignment feature, i.e. also in a mounted position. Further, the removable battery pack and the removable propulsion module of the electrical propulsion system may be connected, such as directly connected or electrically connected, to form a propulsion unit when in their respective mounted positions.

The first alignment feature and the second alignment feature are configured for positioning and fixedly locating a battery pack and a propulsion module relative to each other so that said battery pack and said propulsion module are individually removable. A battery pack and a propulsion module being individually removable is understood as each of a battery pack and a propulsion module removably received at the alignment structure can be removed from the alignment structure without the need for removal of the other of said battery pack and propulsion module from the alignment structure. Further, it may be the case that the first and second alignment features of the alignment structure are configured to provide that the battery pack and the propulsion module remain individually removable also when the alignment structure is received in and affixed to a powered watercraft, e.g. without the need for removal of the alignment structure from said powered watercraft.

The first and second alignment features of the alignment structure may provide that a single mechanical alignment interface can be provided to position and accurately align a removable battery pack and a removable propulsion module relative to each other, e.g. in the space formed there between, rather than having to align each of the removable parts individually relative to a floatation body, such as a hull or substantially rigid main body, of the powered watercraft.

Providing such an alignment interface as a mechanical part separate from a floatation body, such as a hull or a substantially rigid main body, of the powered watercraft is advantageous because it allows for larger manufacturing tolerances for floatation body, such as the hull or main body, of the powered watercraft into which a removable battery pack and a removable propulsion module is intended to be integrated, thus potentially allowing for less complicated designs and simpler manufacturing of said floatation body, hull or substantially rigid main body. By an alignment structure as herein provided instead being positioned and affixed in alignment with the longitudinal direction of a floatation body, hull or substantially rigid main body of an electrical water-jet propelled surfboard, an electrical jetboard manufacturer or surfboard shaper does not need to adapt the surfboard to solve alignment problems both between the removable battery pack and the removable propulsion module and between the surfboard and the removable battery pack and the propulsion module. Rather, a vendor or manufacturer of removable battery packs and/or removable propulsion modules may provide a precisely manufactured alignment structure, which fits into a cavity in said hull or substantially rigid main body and provides alignment features to ensure precise positioning of a removable battery pack and a removable propulsion module relative to each other. Hereby, a simple and reliable alignment aide can be provided to ensure accurately positioning and physical engagement of a contacting portion of the replaceable battery pack with the removable propulsion module or vice versa.

In some embodiments, the alignment structure comprises a releasable fastening element for fixedly locating one or both of a removable battery pack and a removable propulsion module. The releasable fastening elements may for example comprise a snap-lock, a quick-release bracket or a plurality of captive screw fasteners, etc. It is understood that the first and/or second alignment feature may provide releasable fastening elements for receiving a removable battery pack and/or a removable propulsion module. The removable battery pack and/or the removable propulsion module each comprises a compatible fastening elements configured to engage the releasable fastening element, such as a release handle connected to engage/disengage a quick-release bracket, etc. Alternatively or additionally, the alignment structure may comprise fastening elements configured to maintain one or both of the removable battery pack and the removable propulsion module at their respective mounted positions in the alignment structure.

In some embodiments, the alignment structure comprises an opening between the first alignment feature and the second alignment feature. The opening is configured to connect the space occupied by a removable battery pack being received at a first alignment feature with the space occupied by a removable propulsion module being received at a second alignment feature of the alignment structure. The opening may be configured to produce a connection between a contacting portion of a removable battery pack and a contacting portion of a removable propulsion module through the opening. For example, the opening may be configured to allow electrical contacts to be connected when the removable battery pack and/or the removable propulsion module are at their respective mounted positions in the alignment structure. It may also be advantageous that the alignment structure comprises an opening because the alignment structure can then be mounted inside a cavity of a surfboard to divide the cavity into two compartments with the opening providing a connection. Thereby, a battery pack can be mounted in one of the two compartments in the surfboard and a propulsion module can be mounted in the other of the two compartments.

For the present disclosure, the powered watercraft is envisioned as an electrically powered water-jet propelled surfboard comprising a floatation body, such as a hull or substantially rigid main body, which is preferably outfitted with compartments configured to receive a battery pack and a propulsion module such that they are substantially flush with the exterior surface of the surfboard. Thus, it is advantageous to provide an improved electrically powered water-jet propulsion system that can be integrated in a floatation body, such as a hull or substantially rigid main body of the surfboard to receive and align a battery pack and a propulsion module provided within two compartments accessible from an exterior surface of the surfboard. It is moreover advantageous to provide a battery compartment within an upper surface of the surfboard, so that a battery pack can be removably mounted in said battery compartment and at least partially held in place under gravity. Further, it is advantageous to provide a drivetrain compartment within a lower surface or a rear surface of the surfboard, so that at least a water inlet or duct portion of a propulsion module is below the waterline of the surfboard when floating in a body of water. This in turn demonstrates that it may be advantageous for an electrical propulsion system to provide two adjacent compartments for receiving a removable battery pack and a removable propulsion module, e.g. an upper compartment for the battery pack and a drivetrain compartment below the waterline, so that they may be connected.

In some embodiments, the first alignment feature and the second alignment feature overlap a distance as seen along the longitudinal direction, thus, in some embodiments there is an overlap between the first alignment feature and the second alignment feature in the longitudinal direction. In some embodiments, alternatively or additionally, the first alignment feature and the second alignment feature are spaced a distance apart as seen along a vertical axis perpendicular to the longitudinal direction, thus there may be a height difference between the first alignment feature and the second alignment feature.

In some embodiments, the first alignment feature provides a first abutment surface corresponsive to an outer surface of the removable battery pack. The first abutment surface may be corresponsive to an outer surface of the removable battery pack by the first abutment surface being configured to contact a portion of the outer surface of the removable battery pack, such as by the first abutment surface being coplanar or substantially identical in geometrical shape to said portion of the outer surface.

In some embodiments, the second alignment feature provides a second abutment surface corresponsive to an outer surface of the removable propulsion module. The second abutment surface may similarly be corresponsive to an outer surface of the removable propulsion module by the second abutment surface being configured to contact a portion of the outer surface of the removable propulsion module, such as by the second abutment surface being coplanar, complementary or substantially identical in geometrical shape to said portion of the outer surface.

In some embodiments, the first alignment feature and the second alignment feature provide one or more abutment surfaces for abutment between a battery pack and a propulsion module received within said space.

In some embodiments, positioning and fixedly locating the battery pack and the propulsion module relative to each other includes fixing at least three degrees of freedom, such as at least three degrees of freedom, preferably five or six degrees of freedom, between said battery pack and said propulsion module when maintained in abutment against the abutment surfaces. By fixing a degree of freedom, an object being otherwise moveable, such as by linear translation or rotation, along or about an axis of movement associated with said degree of freedom is kept fixed at least with respect to movement along or about said axis of movement. In one example, a releasable latch mechanism may allow some play or rattle while still keeping parts otherwise moveable with respect to each other in a fixed position.

In some embodiments, the first alignment feature includes an opening having substantially smooth sides for slideably receiving the battery pack. The first alignment feature may include an opening configured to be provided substantially flush with an exterior surface of a powered watercraft, such as an electrical water-jet propelled surfboard, when the alignment structure is received in and affixed to a cavity provided in said powered watercraft. The shape of the opening may match or correspond to the shape of the battery pack. For example the opening may be a rectangular or substantially box-shaped aperture configured to receive a rectangular battery pack. By the opening having substantially smooth sides, the battery pack may fit snugly against and slideably engage with said smooth sides to provide good alignment. The slideable engagement may also allow for easier insertion/removal.

In some embodiments, the second alignment feature includes two or more parallel guide rails extending along the longitudinal direction and spaced a distance apart. The two or more parallel guide rails may be spaced a distance apart in a transversal direction, i.e. in a substantially transversal direction, such as a direction perpendicular to the longitudinal direction, such that the propulsion module may fit within the guide rail spacing, and e.g. slideably engage said guide rails to provide alignment.

In some embodiments, the alignment structure provides a mechanical interface for aligning a contacting portion of the battery pack with a contacting portion of the propulsion module to connect electrical contacts provided at said contacting portions with each other, e.g. in the form of mating contacting portions. The mechanical interface may provide a water-tight or substantially water-tight seal between said contacting portions, such as by means of two or more abutment surfaces and resilient sealing elements configured to be maintained in a state of compression between said abutment surfaces when the contacting portions are pressed together. Thus, the mechanical interface may provide a dual function of both guiding said contacting portions into alignment and ensuring a water-tight seal.

In some embodiments, the mechanical interface is configured to fit completely or at least partially into a compartment accessible from an exterior surface of a powered watercraft, such as an engine compartment.

In some embodiments, the mechanical interface is configured to align the contacting portions along the longitudinal direction, a transversal direction perpendicular to the longitudinal direction in the horizontal plane and a vertical direction, and preferably also rotationally, by means of the first and second alignment features.

In some embodiments, the alignment structure is a substantially rigid support frame. The alignment structure may be made of a heat-conducting material, such as metal, such as aluminum or steel, such as a heat-conducting plastic material. This may help to disperse excess heat away from the battery pack and/or the propulsion module received and operably connected within an interior space of the rigid support frame by conducting said excess heat out through the alignment structure.

In some embodiments, the first alignment feature forms a battery cradle configured to support and retain a removable battery pack against the force of gravity when in a mounted position. The battery cradle may be an open-topped metal box or a tray.

In some embodiments, the second alignment feature forms a rear longitudinal channel configured to guide a removable propulsion module into detachable connection with a removable battery pack in a mounted position by slideable engagement with said channel. The rear longitudinal channel may be an elongated channel, for example an extruded metal chute, and may be configured to receive and support an elongated substantially prism- or cuboid-shaped jet drive.

In some embodiments, the alignment structure is an alignment assembly structure comprising a first alignment part and a second alignment part. The first alignment part may comprise the first alignment feature and a third alignment feature. The second alignment part may comprise the second alignment feature and a fourth alignment feature. In some embodiments, the third alignment feature and the fourth alignment feature are configured to position and fixedly locate the first alignment part and the second alignment part relative to each other. In some embodiments, the fourth alignment feature is configured to engage the third alignment feature or vice versa. In some embodiments, the third and fourth alignment features may be configured as mating fastening mechanisms for connecting the first and second alignment parts, such as a first and second fastening mechanism respectively.

Disclosed herein is, in a second aspect of the present disclosure, an electrical propulsion system for a powered watercraft, such as a water-jet propelled surfboard, the electrical propulsion system comprising:
an alignment structure as set out in the first aspect of the present disclosure,
a removable battery pack having a mounted position abutting the first alignment feature, and
a removable propulsion module for propelling the powered watercraft in the longitudinal direction, said removable propulsion module having a mounted position abutting the second alignment feature,
wherein the removable battery pack and the removable propulsion module are operably connectable to each other when both are in their mounted positions.

In some embodiments, the battery pack and the propulsion module are operably connectable by engagement of one or more electrical contacts either directly or indirectly through one or more auxiliary electrical contacts provided at a contacting portion of the alignment structure. The battery pack and the propulsion module may each include mating contacting portions, which each include a plurality of electrical contacts, preferably the same number of electrical contacts being provided by each contacting portion. The contacting portions may be electrically connected with each other, e.g. in the case of multiple contacts, for example when each electrical contact of one contacting portion makes electrical contact with one corresponding electrical contact of the other contacting portion and vice versa. Alternatively, the contacting portions may be electrically connected in indirect ways, e.g. via auxiliary contacts. The one or more electrical contacts may be provided at a contacting portion of the battery pack, thereby being operably connectable with a corresponding contacting portion provided at the propulsion module.

In some embodiments, the electrical propulsion system is configured for installation in a floatation body of a powered watercraft, such as in a hull or main body of a powered watercraft. The floatation body may have a cavity for housing a propulsion module, such as an electric propulsion module, and/or a battery pack. The cavity may be configured for housing the electrical propulsion system. The electrical propulsion system is configured to be received in the cavity for affixing the alignment structure to the floatation body. For example, the electrical propulsion system may, at least when assembled by having received a removable battery pack and a removable propulsion module, have an exterior surface or a general geometrical shape making it suitable for being received in and affixed in the cavity of the floatation body, preferably by the alignment structure being flush with one or more interior surfaces of said cavity.

Disclosed herein is, in a third aspect of the present disclosure, a powered watercraft, such as a water-jet propelled surfboard, comprising:
a floatation body extending in a longitudinal direction and having a cavity for housing a battery pack and/or a propulsion module, and
an alignment structure provided within the cavity and affixed to the floatation body, the alignment structure comprising:
   a first alignment feature configured to receive a removable battery pack; and
   a second alignment feature configured to receive a removable propulsion module for propelling the powered watercraft in the longitudinal direction,
wherein the alignment structure extends longitudinally within the cavity to provide a space for the battery pack and/or the propulsion module, and
wherein the first alignment feature and the second alignment feature are configured for positioning and fixedly locating said battery pack and said propulsion module relative to each other so that they are individually removable.

In some embodiments, the floatation body is a surfboard blank. Alternatively or additionally, the floatation body may be hull or a main body, such as a substantially rigid main body, for a powered watercraft, such as an electrical water-jet propelled surfboard. The floatation body may be understood as a structural part of a watercraft providing an amount of buoyancy, and preferably a load-bearing capacity, for carrying a user. The floatation body may be a surfboard blank, such as a piece of lightweight material provided in a shape roughly reassembling a surfboard and made from an expanded polyurethane and polystyrene (EPS) foam, optionally with the foam being laminated with wood or composite stringers for added structural rigidity. Alternatively or additionally, the floatation body may form part of a hull or substantially rigid main body made from wood, metal or composite materials.

In some embodiments, the alignment structure is affixed to the watercraft at one or more points along the floatation body, such as to an inner surface of the cavity. This may in some embodiments provide an additional rigidity to the floatation body.

In some embodiments, the alignment structure extends in the cavity such that a substantial rigidity is provided between a removable battery pack and a removable propulsion module being removably mounted by means of the alignment structure. The cavity may be an elongated longitudinal cavity, for example extending from a rear portion of the floatation body in a longitudinal direction into a middle portion, such as into at least a middle portion.

The elongated longitudinal cavity may extend in the longitudinal direction from a middle portion to a rear portion of the floatation body. The cavity may extend in the transversal direction having a width being substantially less that the width of the floatation body and extend in a vertical direction from an upper surface of the floatation body to a lower surface and/or to a rear surface of the floatation body. This may provide that the removable propulsion module is provided in a substantially submerged position while non-submersible electronics, such as the battery pack, are provided higher up when received at their respective mounted positions in the alignment structure.

In some embodiments, the powered watercraft further comprises a removable battery pack having a mounted position abutting the first alignment feature and removable in a first direction. In some embodiments, the powered watercraft further comprises a removable propulsion module having a mounted position abutting the second alignment feature and removable in substantially the first direction or in a second direction different from the first direction, such as substantially opposite the first direction. The removable battery pack may be connected to an electric circuit of the removable propulsion module when both said removable battery pack and said removable propulsion module are in their mounted positions. The removable battery pack may be disconnected from the electrical circuit by removal of the removable battery pack and/or the removable propulsion module from the alignment structure. The removable battery pack is configured for providing electrical power stored in the battery pack to an electric circuit of the removable propulsion module. Similarly, the removable propulsion module is configured for propelling the powered watercraft in the longitudinal direction when in the mounted position. By providing an alignment structure with alignment features configured for connecting and disconnecting e.g. an electronic circuit being established between the removable battery pack and the removable propulsion module, the alignment structure provides a good mechanical stability between the removable parts of the electrical propulsion system and allows for safe insertion/removal by disengaging the electrical connection to the battery.

In some embodiments, the removable battery pack is removably positioned in an upper compartment formed in the cavity between the first alignment feature and an upper surface of the floatation body, and wherein the removable propulsion module is removably positioned in a lower compartment correspondingly formed in the cavity between the second alignment feature and a lower surface and/or a rear surface of the floatation body.

In some embodiments, the upper compartment and the lower compartment partly overlap each other a distance as seen along the longitudinal direction. In some embodiments, the upper compartment and the lower compartment partly overlap a distance as seen along a vertical axis perpendicular to the longitudinal direction.

Disclosed herein is, in a fourth aspect of the present disclosure, a method of securing a removable battery pack and a removable propulsion module within a watercraft body for a powered watercraft, such as a water-jet propelled surfboard, the method comprising the steps of:
providing a watercraft body extending in a longitudinal direction and having a cavity,
providing an alignment structure comprising a first alignment feature configured to receive a removable battery pack and a second alignment feature configured to receive a removable propulsion module for propelling the powered watercraft in the longitudinal direction,
positioning the alignment structure in the cavity so that the first alignment feature and the second alignment feature provide a space for positioning and fixedly locating a removable battery pack and a removable propulsion module relative to each other so that they are individually removable, and
securing the alignment structure to the watercraft body.

Hereby one or more advantages as described above in relation to the other aspects may be obtained. For example, this may provide a solution which enables improved alignment accuracy, a cheaper or less complicated design or faster manufacturing of a watercraft body for a powered watercraft adapted for securing a removable battery pack and a removable propulsion module within said watercraft body.

In some embodiments, the watercraft body comprises a floatation body. Alternatively or additionally, the watercraft body may be hull or a substantially rigid main body for a powered watercraft, such as an electrical water-jet propelled surfboard. The term “watercraft body” may be understood as a structural part of a watercraft providing an amount of buoyancy, structural rigidity and load-bearing capacity for carrying a user. The watercraft body may for example include a floatation body in the form of a blank for a surfboard, wherein a cavity is formed in the blank and the watercraft body then structurally reinforced with fiberglass or fiber-reinforced resin at an exterior surface. Further, the term “floatation body” may be understood to at least infer buoyancy.

In some embodiments, the watercraft body is a surfboard or a board-like structure configured to be used as a water-jet propelled surfboard when fully assembled.

Disclosed herein is, in a fifth aspect of the present disclosure, a kit of parts of a powered watercraft, such as a jetboard, to be assembled by a user, such as by a method according to the fourth aspect, the kit of parts comprising:
a battery pack;
a propulsion module for propelling the powered watercraft;
an alignment structure comprising:
   a first alignment feature configured to receive the battery pack at a first position to power to the propulsion module, and
   a second alignment feature configured to receive the propulsion module at a second position to propel the powered watercraft;
and
optionally, a floatation body extending in a longitudinal direction and having a cavity for housing at least the alignment structure;
wherein the battery pack and the propulsion module are operably connectable to each other by means of the alignment structure, and wherein the alignment structure is configured to be received in a/the cavity of, and/or affixed to, a/the floatation body so that the alignment structure extends along a/the longitudinal direction and allows the battery pack and the propulsion module to be received in and individually removable from their respective received positions.

Disclosed herein is, in a further aspect of the present disclosure, an alignment assembly structure for a battery pack for a powered watercraft, such as a jetboard, wherein the alignment assembly structure is configured to be received in and affixed to said powered watercraft, the alignment assembly structure comprising:
a first alignment part comprising:
   a first alignment feature configured to receive a removable battery pack, and
   a first fastening mechanism; and
a second alignment part comprising:
   a second alignment feature configured to receive a removable propulsion module for propelling the powered watercraft in a longitudinal direction, and
   a second fastening mechanism configured to engage the first fastening mechanism to fixedly maintain the second alignment part in position relative to the first alignment part;
wherein the first alignment part and the second alignment part are rigidly connectable by means of the first and second fastening mechanisms, and
wherein, at least when connected, the alignment assembly structure extends along the longitudinal direction to provide a space for the battery pack and/or the propulsion module, and
wherein the first alignment feature and the second alignment feature are configured for positioning and fixedly locating said battery pack and said propulsion module relative to each other so that said battery pack and said propulsion module are individually removable.

The present invention relates to different aspects including the structure described above and in the following, and corresponding structure parts, methods, devices, systems, networks, uses and/or product means, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

Various examples are described hereinafter with reference to the figures. Like reference numerals refer to like elements throughout. Like elements will, thus, not be described in detail with respect to the description of each figure. It should also be noted that the figures are only intended to facilitate the description of the examples. They are not intended as an exhaustive description of the claimed invention or as a limitation on the scope of the claimed invention. In addition, an illustrated example needs not have all the aspects or advantages shown. An aspect or an advantage described in conjunction with a particular example is not necessarily limited to that example and can be practiced in any other examples even if not so illustrated, or if not so explicitly described.

FIG. 1 illustrates a powered watercraft comprising an alignment structure for a battery pack and a propulsion module according with one or more embodiments of the present disclosure.

FIG. 2 illustrates a floatation body having a cavity for housing a battery pack and a propulsion module, wherein an alignment structure is received in said cavity and is affixed to the floatation body to form upper and lower compartments.

FIG. 3 illustrates a powered watercraft in the form of a jetboard, i.e. a water-jet propelled surfboard, comprising an alignment structure, a removable battery pack and a water-jet propulsion module propelling the jetboard in a forward direction.

FIG. 4 illustrates a cross-sectional view of a powered watercraft in the form of a jetboard, such as for example illustrated in FIG. 3, giving a side-view of the alignment structure receiving a removable battery pack and a removable propulsion module in an embodiment where their respective electrical contacts are brought into contact.

FIG. 5 illustrates another cross-sectional view of a powered watercraft in the form of a jetboard, such as for example illustrated in FIG. 3, giving a top-down view of the alignment structure in an embodiment providing auxiliary electrical contacts between contacting portions of a battery pack and a propulsion module.

FIG. 6a illustrates an electrical propulsion system for a powered watercraft, such as e.g. illustrated in FIGS. 1-5, wherein the electrical propulsion system comprises an alignment structure for a removable battery pack for a powered watercraft.

FIG. 6b illustrates an electrical propulsion system for a powered watercraft, such as e.g. illustrated in FIGS. 1-5, wherein the electrical propulsion system comprises a removable battery pack removably mounted at the alignment structure.

FIG. 6c illustrates an electrical propulsion system for a powered watercraft, such as e.g. illustrated in FIGS. 1-5, wherein the electrical propulsion system comprises a removable propulsion module removably mounted at the alignment structure.

FIG. 6d illustrates an electrical propulsion system for a powered watercraft, such as e.g. illustrated in FIGS. 1-5, wherein the electrical propulsion system comprises a removable battery pack and a removable propulsion module removably mounted at the alignment structure, such that they are electrically connected with each other.

FIG. 7 illustrates another embodiment of an alignment structure for a battery pack and a propulsion module for a powered watercraft, such as a jetboard e.g. illustrated in FIG. 3, wherein the alignment structure is an assembly of a first and a second part.

FIG. 8 illustrates an upside-down view of yet another embodiment of an alignment assembly structure, such as e.g. illustrated in FIG. 7, comprising a first and a second part affixed together and further comprising an opening therein.

FIG. 9 illustrates an alignment assembly structure, such as e.g. illustrated in FIGS. 7-8, being assembled from a first alignment part for a removable battery pack and a second alignment part for a removable propulsion module for a jetboard.

FIG. 10 illustrates another embodiment of a floatation body of a water-jet propelled watercraft, such as a hull or substantially rigid main body of a jetboard, wherein an alignment structure is provided within a cavity in said floatation body.

FIG. 11 illustrates an upside-down view of yet another embodiment of a floatation body of a water-jet propelled watercraft, such as e.g. illustrated in FIG. 10, wherein the floatation body has an opening between an upper and a lower compartment.

FIG. 12 is a top perspective view of an alternative watercraft with a battery pack and a propulsion module installed.

FIG. 13 is a perspective bottom view of the watercraft of FIG. 12.

FIG. 14 is an exploded view of the water craft with battery pack and propulsion module of FIG. 12.

FIG. 15 shows the watercraft of FIG. 12 during installation of the battery pack and the propulsion module.

FIG. 16a is a view similar to FIG. 13 showing installation of the propulsion module, and

FIG. 16b is a top perspective view of the watercraft of FIG. 12, after installation of the propulsion module.

### DESCRIPTION OF EXAMPLES

Exemplary examples will now be described more fully hereinafter with reference to the accompanying drawings. In this regard, the present examples may have different forms and should not be construed as being limited to the descriptions set forth herein. Accordingly, the examples are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

The spatially relative terms “lower” or “bottom” and “upper” or “top”, “below”, “beneath”, “less”, “above”, and the like, may be used herein for ease of description to describe the relationship between one element or component and another element or component as illustrated in the drawings. It will be understood that the spatially relative terms are intended to encompass different orientations of the device in use or operation, in addition to the orientation depicted in the drawings. For example, in the case where a device illustrated in the drawings is turned over, elements described as being on the “lower” side of other elements, or “below” or “beneath” another element would then be oriented on “upper” sides of the other elements, or “above” another element. Accordingly, the illustrative term “below” or “beneath” may include both the “lower” and “upper” orientation positions, depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below, and thus the spatially relative terms may be interpreted differently depending on the orientations described.

Throughout the specification, when an element is referred to as being “connected” to another element, the element is “directly connected” to the other element, or “electrically connected” to the other element with one or more intervening elements interposed therebetween.

The terminology used herein is for the purpose of describing particular examples only and is not intended to be limiting. As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises,” “comprising,” “includes” and/or “including,” when used in this specification, specify the presence of stated features, integers, steps, operations, elements, and/or components, but do not preclude the presence or addition of one or more other features, integers, steps, operations, elements, components, and/or groups thereof.

It will be understood that, although the terms “first,” “second,” “third,” and the like may be used herein to describe various elements, these elements should not be limited by these terms. These terms are only used to distinguish one element from another element. Thus, “a first element” discussed below could be termed “a second element” or “a third element,” and “a second element” and “a third element” may be termed likewise without departing from the teachings herein.

“About”, “approximately” or “substantially” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within ±30%, 20%, 10%, 5% of the stated value.

Unless otherwise defined, all terms used herein (including technical and scientific terms) have the same meaning as commonly understood by those skilled in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined in the present specification.

Exemplary examples are described herein with reference to cross section illustrations that are schematic illustrations of idealized examples, wherein like reference numerals refer to like elements throughout the specification. As such, variations from the shapes of the illustrations as a result, for example, of manufacturing techniques and/or tolerances, are to be expected. Thus, examples described herein should not be construed as limited to the particular shapes of regions as illustrated herein but are to include deviations in shapes that result, for example, from manufacturing. For example, a region illustrated or described as flat may have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. Some of the parts which are not associated with the description may not be provided in order to specifically describe exemplary examples of the present disclosure.

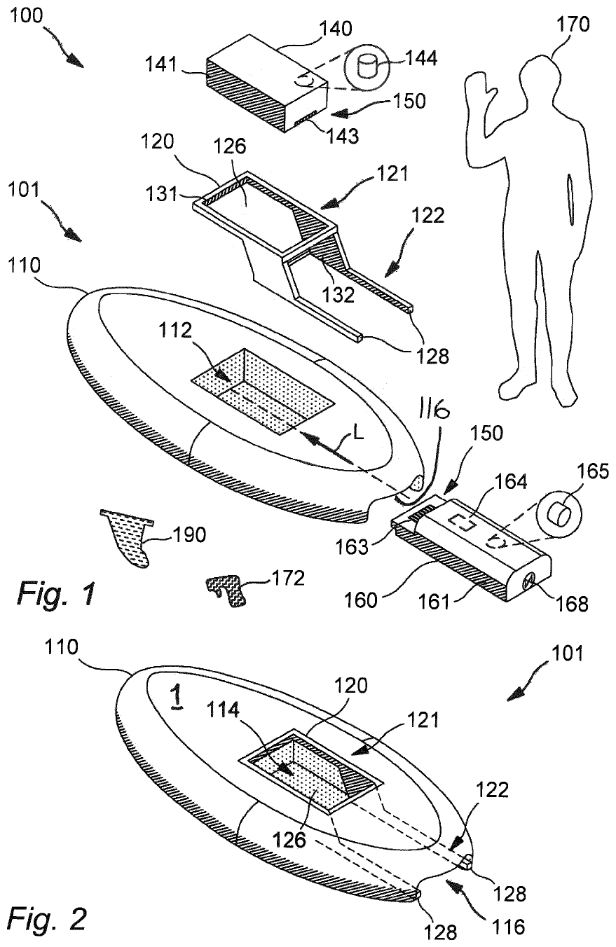

FIG. 1 is an illustration of a powered watercraft 100 for water sports and leisure activity. The powered watercraft 100 is shown in the form of an electrically powered water-jet propelled surfboard 101, which is also known as a jetboard 100, 101. The powered watercraft 100 comprises a floatation body 110 extending in a longitudinal direction L. The floatation body 110 is shown in the shape of a surfboard or a blank for a surfboard e.g. made from a polyurethane or expanded polystyrene (EPS) foam. The floatation body 110 may form part of a hull or substantially rigid main body of a powered watercraft 100, e.g. in the form of a water-jet propelled surfboard 101. An elongated cavity 112 is provided in the floatation body 110. The cavity 102 extends in a longitudinal direction L from a middle portion of the floatation body 110 to a rear portion of the floatation body 110 furthest in an opposite direction to the longitudinal direction L. Hereby, an elongated longitudinal cavity 112 is provided in the floatation body 110 for housing a battery 140 and a propulsion module 160.

The jetboard 100, 101 is illustrated as a kit of parts to be assembled by a user 170, a manufacturer or a surfboard shaper. The jetboard 100, 101 in its assembled state comprises a hull or substantially rigid main body 110 for the user 170 to stand on when the jetboard 100, 101 is in use, i.e. floating on a body of water. Thus, the floatation body 110 provides buoyancy to counteract the combined weight of the jetboard 100, 101 and a user 170 riding it so that they remain afloat on the water. An electrical propulsion system comprising a battery pack 140 and electrical propulsion means 160 for the powered watercraft 100 may be provided to the jetboard 100, 101 in order to propel the jetboard 100, 101 in a longitudinal direction L over the water.

Additionally, the jetboard 100, 101 may be operable by the user 170 by means of a controller 172, such as a wireless handgrip providing speed control of the propulsion module 160 as shown here. Thus, the user 170 may control the linear motion of the jetboard 100, 101 by controlling a controllable function of the propulsion module 160 using the controller 172. Further, the jetboard 100, 101 may have removable or fixed steering means 190 for controlling the heading of the jetboard 100, 101 by affecting a longitudinal direction L in which the linear thrust is being provided by the propulsion module 160. In this way, the user 170 may be able to control speed and heading of the jetboard 100, 101 across a body of water in a variety of weather conditions.

An electrical battery pack 140 is shown comprising at least one rechargeable battery cell 144 enclosed inside a water-tight housing forming an outer surface 141 around the battery cells 144 in the battery pack 140. The battery pack 140 is shown with a contacting portion 150 comprising a plurality of electrical contacts 143 for connecting the battery pack 140 to an external charger or a load to receive or deliver an amount of electrical power to or from the battery cells 144, respectively. Here, the electrical contacts 143 of the contacting portion 150 of the battery pack 140 are configured to provide that an external contacting portion having matching electrical contacts may engage and electrically connect to said battery contacts 143. Thus, the battery pack 140 is configured to be removable, e.g. from a battery compartment or the like, and to receive and/or deliver electrical power by means of the contacting portion 150.

An electrical propulsion module 160 is shown in the form of an electrically powered water-jet propulsion drive 160 for a jetboard 100,101. The propulsion module 160 is shown with a contacting portion 150 comprising a plurality of electrical contacts 163 for connecting to the corresponding contacting portion 150 of the battery pack 140, thereby making an electrical connection between the battery contacts 143 and the propulsion contacts 163 to deliver electrical power from the battery pack 140 to the propulsion module 160. The propulsion module 160 is further shown comprising an electrical circuit 164 configured to receive power from the battery cells 144 via the electrical contacts 143,164 and to deliver power to the propulsion module 160.

The propulsion module 160 comprises an electrical motor 165 enclosed inside a water-tight housing forming an outer surface 161 around the electrical components 164, 165 of the propulsion module 160. As above, the electrical contacts 163 of the contacting portion 150 of the propulsion module 160 are configured to provide that an external contacting portion having matching electrical contacts may engage and electrically connect to said propulsion contacts 163. Likewise, the propulsion module 160 also is configured to be removable, e.g. from a drivetrain compartment or from a battery 140, and to receive electrical power by means of the contacting portion 150.

In this example, the propulsion module comprises an electrical motor 165 connected to an impeller 168, e.g. via a shaft, configured to produce a water-jet by accelerating water received from an inlet or duct portion provided in the housing 161 out through a jet nozzle in response to the motor 165 causing the impeller 168 to rotate rapidly.

It is understood that the propulsion module 160 may advantageously be provided as an integrated water-jet drive unit comprising an electromotor 165, an electrical circuit 164 configured to control and/or provide power to said electromotor 165, an impeller 168 driven by said electromotor 165 and further hydrodynamic parts, such as water inlets or ducts and jet nozzles necessary to produce a water-jet. Such an integrated water-jet drive unit 160 may provide that any user 170 can easily remove the entire propulsion means 160 without having to access sensitive electronics 164 or knowing how to disassemble a water-jet drive into constituent parts 165, 168 to remove them. Thus, the propulsion module 160 is configured to be removable, e.g. from a waterjet drivetrain compartment or the like provided in a jetboard 100, 101, such as in a rear portion of the cavity 112 of the floatation body 110 shown here.

An alignment structure 120 is shown having a geometrical shape for being provided within the cavity 112 so that the alignment structure 120 extends longitudinally within the cavity 112. Once in position in the cavity 112, the alignment structure 120 may be affixed to the flotation body 110, such as rigidly affixed to the floatation body 110, for example by means of an adhesive, such as an epoxy resin. The alignment structure 120 is for a battery pack 140 and electrical propulsion means 160 for a powered watercraft 100, such as a jetboard 101. The alignment structure 120 is configured to be received in and rigidly affixed to said powered watercraft 100, for example in the cavity 112 of the floatation body 110 of the powered watercraft 100. Preferably, the alignment structure 120 may be insertable into a cavity 112 the floatation body 110 of the powered watercraft 100 so that one end portion of the alignment structure 120 is provided substantially flush with an exterior surface of the powered watercraft 100, e.g. thereby providing one compartment, and another and portion of the alignment structure 120 is provided substantially flush with the exterior surface at an opposite end of said cavity 112, e.g. thereby providing another compartment opposite the one compartment.

The alignment structure 120 comprises a first alignment feature 121 configured to receive a removable battery pack 140, such as the rectangular box-shaped battery pack 140 shown here. The alignment structure 120 comprises a second alignment feature 122 configured to receive a removable propulsion module 160 for propelling the powered watercraft 100 in the longitudinal direction L, i.e. in a generally forward direction substantially following a horizontal plane, such as across a body of water. The second alignment feature 122 is configured to receive a removable propulsion module 160, such as the elongated propulsion module 160 shown here.

The first alignment feature 121 and the second alignment feature 122 are configured for receiving a removable battery pack 140 and a removable propulsion module 160, respectively, to thereby position and fixedly locate the received battery pack 140 and the received propulsion module 160 relative to each other.

The first alignment feature 121 and the second alignment feature 122 provide one or more abutment surfaces 131, 132 for abutment between the removable battery pack 140 and the removable propulsion module 160 when received against or in a space between the first and second alignment features 121, 122.

The first alignment feature 121 is shown with a first abutment surface 131 which is corresponsive to an outer surface 141 of the removable battery pack 140. Similarly, the second alignment feature 122 is shown with a second abutment surface 132 corresponsive to an outer surface 161 of the removable propulsion module 160.

In this embodiment, the first alignment feature 121 includes an opening 126 having substantially smooth sides 131 for slideably receiving the battery pack 140. Further, in this embodiment, the second alignment feature 122 includes two guide rails 128 which are substantially parallel and extending along the longitudinal direction L. As shown here, the first alignment feature 121 and the second alignment feature 122 are configured for positioning and fixedly locating a removable battery pack 140 and a removable propulsion module 160 relative to each other e.g. by first receiving the battery pack 140 through the opening 126 and then receiving the propulsion module 160 in the space between the two guide rails 128 such that the battery pack 140 and propulsion module 160 are brought together, for example to make direct contact with each other at one or more contacting portions 150.

FIG. 2 is an illustration of a floatation body 110 for a powered watercraft 100, such as e.g. illustrated in FIG. 1, wherein an alignment structure 120 has been received in a cavity provided in the floatation body 110 and affixed to the floatation body 110 to form an upper compartment 114 and a lower compartment 116. The cavity in this illustration is only partially visible due to the alignment structure 120 occupying a portion of the cavity. It is understood that the floatation body 110 is here shown as a comparable embodiment to the floatation body 110 shown in FIG. 1, thus having the same cavity as the elongated longitudinal cavity 112 discussed above. The cavity for housing electric propulsion means is here housing the alignment structure 120.

The alignment structure 120 extends longitudinally within the cavity in the floatation body 110, as shown, to provide compartments 114, 116 for an electrical propulsion system comprising a removable battery pack and a removable propulsion module, e.g. the battery pack and propulsion module shown in FIG. 1 and discussed above. This electrical propulsion system may be configured for installation in the floatation body 110 to provide a powered watercraft. By installing the alignment structure 120 in the floatation body 110, as shown here, the floatation body 110 is configured to receive said electrical propulsion system e.g. by receiving a removable battery pack against a first alignment feature 121 provided by the alignment module 120 within an upper compartment 114 of the floatation body 110 and further receiving a removable propulsion module against a second alignment feature 122 likewise provided by the alignment module 120 within a lower compartment 116 of the floatation body 110. In this example, the battery pack and the propulsion module may become electrically connected when received in their respective compartments 114, 116 by engagement of one or more electrical contacts through the cavity or by a connection between the upper compartment 114 and the lower compartment 116.

As discussed above in relation to FIG. 1, the alignment structure 120 being received within a cavity in a floatation body 110 and being affixed forms compartments 114, 116 for receiving a removable battery pack and a removable propulsion module. The upper compartment 114 is here shown formed from an opening 126 in an upper surface of the floatation body 110, the opening having substantially smooth vertical sides extending downwardly into the cavity in the floatation body 110. The lower or rear compartment 116 is shown analogously formed from a rear longitudinal channel at a rear surface of the floatation body 110 extending inwardly towards the cavity. In addition to the first alignment feature 121 including a comparable opening 126 being provided substantially flush with an upper surface of the floatation body 110, so that a battery pack can be removable received in an upper compartment 114, the second alignment feature 122 includes two substantially parallel guide rails 128 extending in rearward direction from the middle portion of the floatation body 110 and out through the lower or rear compartment 116 to removably received a propulsion module.

Hereby, the first alignment feature 121 and the second alignment feature 122 of the alignment structure 120 allow for positioning and fixedly locating a battery pack and a propulsion module relative to each other so that they are individually removable.

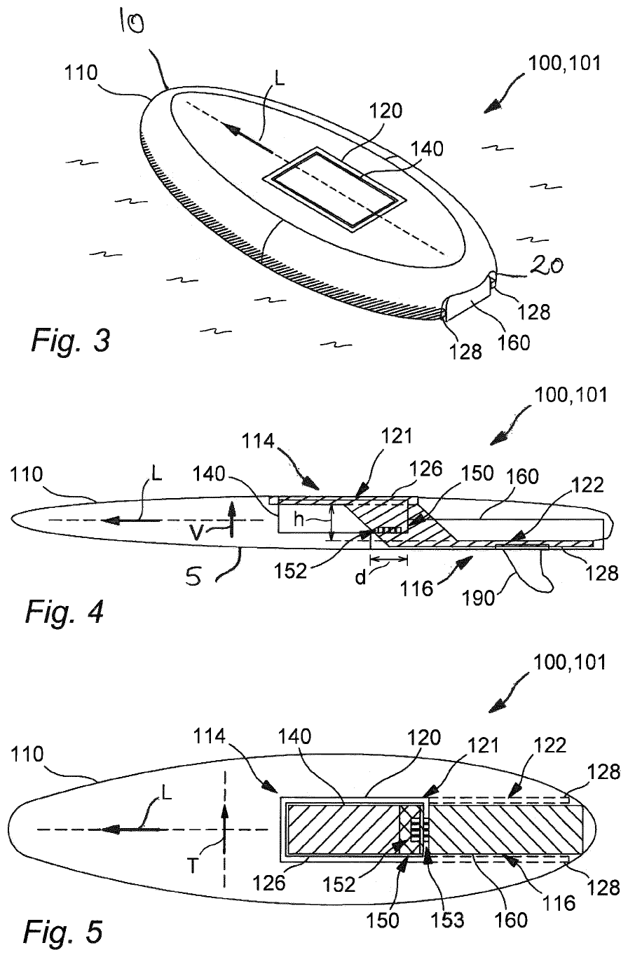

FIG. 3 is an illustration of an electrically powered watercraft 100 in the form of an electrical water-jet propelled surfboard 101, such as e.g. illustrated in FIG. 1, shown in an assembled state comprising a watercraft body 110 with an alignment structure 120 affixed to said body 110, such as e.g. illustrated in FIG. 2, and wherein a removable battery pack 140 and a removable propulsion module 160 are removably mounted and fixedly located relative to each other by being received against the alignment features of the alignment structure 120. The assembled waterjet 100, 101 is hereby configured to self-propel in a longitudinal direction L over a body of water, and by the watercraft body 110 being buoyant, this allows for transporting a user.

FIG. 4 is an illustration of a cross-sectional view of a powered watercraft 100 in the form of a jetboard 101 in an assembled state, such as e.g. illustrated in FIG. 3. The cross-sectional view is provided across a cross-sectional plane intersecting the jetboard 101 along a centerline of the floatation body 110, e.g. as indicated by the dashed line in FIG. 3, the cross-sectional plane spanned by a longitudinal direction L and a vertical direction V to give a side-view of an assembled jetboard 100, 101.

The cross-sectional view shows an alignment structure 120 affixed within a cavity in the floatation body 110 to form upper and lower compartments 114, 116 as discussed above in relation to FIGS. 1-2. The alignment structure 120 comprises a first alignment feature 121 providing an opening 126, through which a removable battery pack 140 has been received. The alignment structure 120 also comprises a second alignment feature 122 providing a guide rail 128, against which a removable propulsion module 160 has been received. As shown, the first and second alignment features 121, 122 allow for positioning and fixedly locating the battery pack 140 and the propulsion module 160 relative to each other such that the battery pack 140 and the propulsion module 160 are individually removable, i.e. by removal of the battery pack 140 from the upper compartment 114 and/or removal of the propulsion module 160 from the lower or rear compartment 116, which is very convenient for a user.

In this embodiment, the first alignment feature 121 and the second alignment feature 122 overlap a distance d as seen along the longitudinal direction L. Further, in this embodiment, the first alignment feature 121 and the second alignment feature 122 are spaced a height h apart as seen along a vertical direction V perpendicular to the longitudinal direction L. The vertical direction V may be understood as the direction opposite the direction of the force of gravity acting on the jetboard 100, 101 when in a upright position when floating on a body of water during normal operation.

In this embodiment, the alignment structure 120 has alignment features 121, 122 that are positioned relative to each other so that a contacting portion 150 of a removable battery pack 140 is brought into contact with a compatible contacting portion 150 of a removable propulsion module 160 when both are received against the alignment features 121, 122. This allows for electrical connections to be established between electrical contacts 152 provided at the respective contacting portions 150, thereby enabling the battery pack 140 to provide power to the propulsion module 160.

FIG. 5 is an illustration of another cross-sectional view of a powered watercraft 100 in the form of a jetboard 101 in an assembled state, such as e.g. illustrated in FIGS. 3-4. Compared to the cross-sectional view illustrated in FIG. 3, another cross-sectional view is provided across another cross-sectional plane also intersecting the jetboard 101 along a centerline of the floatation body 110, e.g. as indicated by the dashed line in FIG. 3, and coplanar to a horizontal plane. Consequently, the another cross-sectional plane is spanned by the same longitudinal direction L as in FIGS. 3-4 and a transversal direction T perpendicular to the longitudinal direction L to give a top-down view of the assembled jetboard 100, 101 as illustrated in FIGS. 3-4.

The transversal direction T may be understood as a direction perpendicular to the longitudinal direction L in the horizontal plane of the jetboard 100, 101 when in a upright position when floating on a body of water during normal operation.

Compared to FIG. 4, this cross-sectional view shows a slightly different embodiment of an alignment structure 120 affixed within a cavity in the floatation body 110, i.e. comprising substantially identical alignment features 121, 122 which provide an opening 126 for a removable battery pack 140 and guide rails 128 for the removable propulsion module 160, which are arranged with their respective contacting portions 150 in close proximity to one another in the upper and lower compartments 114, 116. However, in this embodiment, electrical contacts 152; 143, 163 provided at contacting portions 150 of the battery pack 140 and the propulsion module 160 are electrically connected by engagement of one or more auxiliary electrical contacts 153 provided at a contacting portion 150 of the alignment structure 120.

As hereby illustrated, an alignment structure may provide a mechanical interface 150 for aligning and securing a contacting portion 143; 150 of the battery pack 140 with a compatible contacting portion 163; 150 of electrical propulsion means 160 to connect electrical contacts 152 at the contacting portions 143, 163; 150 with each other. Hereby, a safe and reliable electrical connection is made between them.

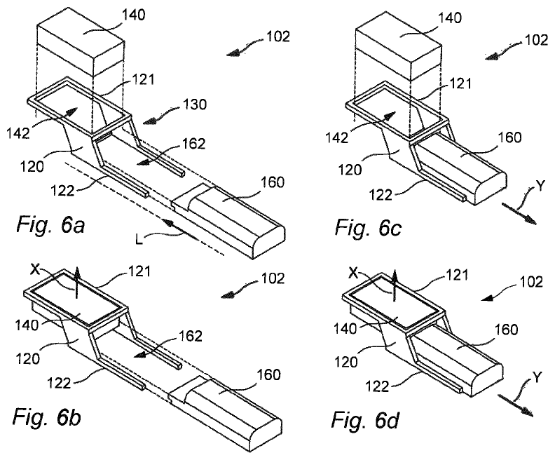

FIG. 6a is an illustration of an electrical propulsion system 102 for installation in a powered watercraft, such as e.g. a jetboard as illustrated in FIGS. 1-5. The electrical propulsion system 102 comprises an alignment structure 120 for a battery pack 140 and electrical propulsion means 160 suitable for propelling the powered watercraft. The alignment structure 120 extends along a longitudinal direction L to provide a space 130 for the battery pack 140 and/or the propulsion module 160.

The electrical propulsion system 102 is shown as a kit of parts for installation in a powered watercraft 100, such as a water-jet propelled surfboard 101, the electrical propulsion system 102 comprising an alignment structure 120, a removable battery pack 140 and a removable propulsion module 160. As discussed above in relation to FIGS. 1-5, the alignment structure 120 comprises a first alignment feature 121 which is configured to receive the removable battery pack 140 and the alignment structure 120 comprises a second alignment feature 122 configured to receive the removable propulsion module 160. The alignment structure 120 extends along a longitudinal direction L, which provides a space 130 for the battery pack 140 and the propulsion module 160 to be received at least partially within the alignment structure 120. The removable battery pack 140 is hereby provided with a mounted position 142, where an outer surface of the battery pack 140 is abutting the first alignment feature 121. The battery pack 140 is shown in a removed state above its mounted position 142 abutting the first alignment feature 121. Likewise, the removable propulsion module 160 is provided with a mounted position 162 adjacent the mounted position 142 of the battery pack 140, where an outer surface of the propulsion module pack 160 is abutting the second alignment feature 122. The propulsion module 160 is shown in a removed state away from its mounted position 162 abutting the second alignment feature 122, i.e. being shifted a distance away from the mounted position 162 in a direction substantially opposite the longitudinal direction L.

In this embodiment, the removable battery pack 140 and the removable propulsion module 160 are operably connectable to each other when both are at their mounted positions 142, 162, as for example discussed above in relation to FIGS. 1-5.

The first alignment feature 121 and the second alignment feature 122 are configured for positioning and fixedly locating said battery pack 140 and said propulsion module 160 relative to each other. This provides an electrical propulsion system 102 for any manufacturer or skilled operator to install in an electrically powered watercraft, such as an electrical water-jet propelled surfboard, where it is desirable to allow a battery pack 140 and a propulsion module 160 to be individually removable.

FIG. 6b is an illustration of an electrical propulsion system 102 for installation in a powered watercraft, such as e.g. a jetboard as illustrated in FIGS. 1-5. The electrical propulsion system 102 is shown in a partially assembled state, wherein compared to the electrical propulsion system 102 illustrated in FIG. 6a, the removable battery pack 140 is here shown mounted in the mounted position with an outer surface of the propulsion module pack 160 abutting the second alignment feature 122. Hereby, the electrical propulsion system 102 comprises a removable battery pack 140 being removably mounted at the alignment structure 120. The removable battery pack 140 is shown being removable by displacement along a first direction X.

FIG. 6c is an illustration of an electrical propulsion system 102 for installation in a powered watercraft, such as e.g. a jetboard as illustrated in FIGS. 1-5. The electrical propulsion system 102 is shown in a partially assembled state, wherein compared to the electrical propulsion system 102 illustrated in FIG. 6a, the removable propulsion module 160 is here shown mounted in the mounted position with an outer surface of the propulsion module pack 160 abutting the second alignment feature 122. Hereby, the electrical propulsion system 102 comprises a removable propulsion module 160 being removably mounted at the alignment structure 120. The removable propulsion module 160 is shown being removable by displacement along a second direction Y.

FIG. 6d is an illustration of an electrical propulsion system 102 for installation in a powered watercraft, such as e.g. a jetboard as illustrated in FIGS. 1-5. The electrical propulsion system 102 is shown in a fully assembled state, wherein compared to the electrical propulsion system 102 illustrated in FIGS. 6a-c, the removable battery pack 140 and the removable propulsion module 160 are connected, e.g. as discussed in relation to FIGS. 1-5, and here shown mounted in their respective mounted positions abutting the alignment features 121,122. Compared to FIG. 6a illustrating the electric propulsion system 102 in an unassembled state, the removable battery pack 140 in this illustration may be electrically connected to an electrical circuit provided as part of the removable propulsion module 160, wherein the electrical circuit for example is configured to receive power from the battery pack 140 and deliver said power to the removable propulsion module 160, optionally by performing power conversion.

As discussed above in relation to FIGS. 1-5; 6a-c, the electrical propulsion system 102 comprises a removable battery pack 140, an electrical propulsion module 160 configured to propel a powered watercraft and an alignment structure 120 for said battery pack 140 and electrical propulsion means 160 for a powered watercraft. The alignment structure 120 comprises a first alignment feature 121, which is configured to receive the removable battery pack 140, and also comprises a second alignment feature 122 configured to receive the removable propulsion module 160.

The first alignment feature 121 and the second alignment feature 122 are configured for positioning and fixedly locating said battery pack 140 and said propulsion module 160 relative to each other such that the battery pack 140 and the propulsion module 160 are individually removable. This removability may particularly be advantageous for an alignment structure 120 received in and affixed to a power watercraft, e.g. a jetboard, so that the electrical propulsion system 102 is modularly installed.

In this example, the electrical propulsion system 102 comprises a removable battery pack 140 provided at a mounted position abutting the first alignment feature 121 and being removable in a first direction (X). Further, the electrical propulsion system 102 comprises a removable propulsion module 160 also provided at a mounted position abutting the second alignment feature 122 and removable in a second direction Y. The second direction Y may be substantially the same or along to the first direction X, or the second direction Y may be substantially different from the first direction X, such as substantially opposite or perpendicular to the first direction X.

Thus, the electrical propulsion system 102 comprises a removable battery pack 140 and a removable propulsion module 160 both removably mounted at the alignment structure 120, such that they are electrically connected with each other. This may provide a mechanical interface which ensures that the removable battery pack 140 is disconnected from the electrical circuit by removal of the removable battery pack 140 and/or the removable propulsion module 160 from the alignment structure 120.

It is understood that the electrical propulsion system 102 is intended to be installed, preferably, by first installing the alignment structure 120 in a cavity or vacant space provided in a hull or substantially rigid main body of a power watercraft, such as in a cutout portion of a surfboard blank or similar. Subsequently, for example once other manufacturing steps have been completed, the removable battery pack 140 and the removable propulsion module 160 are inserted at their respective mounted positions within the alignment structure 120 installed to form a finished powered watercraft. It is moreover contemplated by the inventors that the electrical propulsion system 102 could be installed in the partially assembled state, e.g. as illustrated in FIGS. 6b-c, or even in the fully assembled illustrated here, to further reduce manufacturing costs.

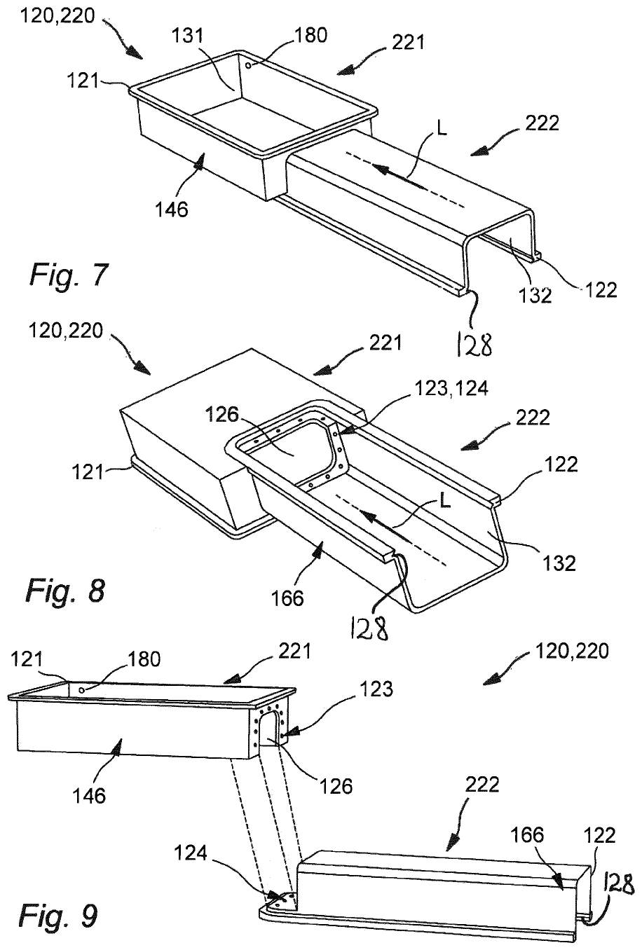

FIG. 7 is an illustration of another embodiment of an alignment structure 120 for a battery pack and a propulsion module for a powered watercraft, such as a jetboard e.g. illustrated in FIGS. 1-5. The alignment structure 120 in this embodiment is an alignment assembly 120 comprising, or consisting essentially of, a first alignment part 221 and a second alignment part 222. The first alignment part 221 comprises a first alignment feature 121 configured to receive a removable battery pack, such as e.g. discussed in relation to FIGS. 1-5; 6a-d above. The first alignment part 221 may also comprise an additional alignment feature and/or fastening means configured for rigidly connecting the first alignment part 221 and the second alignment part 222 to maintain the alignment assembly 120 in an assembled state, such as shown here.

Further, the second alignment part 222 comprises a second alignment feature 122 configured to receive a removable propulsion module, such as e.g. also discussed in relation to FIGS. 1-5; 6a-d above. The second alignment part 222 may comprise an additional alignment feature and/or fastening means compatible with corresponding features/means at the first alignment part 221 and configured for rigidly connecting the first alignment part 221 and the second alignment part 222 when engaged with one another to maintain the alignment assembly 120 in an assembled state.

The first alignment feature 121 is shown with a first abutment surface 131 forming a battery cradle 146. The battery cradle 146 may be shaped as an open-topped rigid box, as for example shown here. The battery cradle 146 is configured to support and retain a substantially box-shaped battery pack received at the first alignment feature 121. The battery cradle 146 may be configured to at least partly counteract the force of gravity acting on a substantially box-shaped battery pack, preferably in more than one orientation, when mounted in the alignment assembly structure 120,220. A box-shaped battery pack may be held in place in the battery cradle 146 under the force of gravity, preferably in more than one orientations, because the battery cradle 146 has a geometrical shape compatible or configured to receive such a battery pack. In this example, fastening means 180 is provided by the first alignment feature 121 and configured to removable attach such a battery pack when mounted in the alignment structure 120,220. For example, the fastening means 180 may be a releasable latch or ball detent providing that the battery pack is kept in the battery cradle 146.

The second alignment feature 122 is shown with a second abutment surface 132, which is described in more detail in relation to a different view provided in FIG. 8. The alignment assembly structure 120,220 extends longitudinally in the assembled state to provide a space for the battery pack 140 and the propulsion module 160. A longitudinal direction L of the alignment assembly structure 120,220 is shown as the general direction of propulsion when the alignment assembly structure 120,220 is in use, i.e. housing a battery pack and a propulsion module to propel a watercraft.

FIG. 8 is an illustration of an alignment assembly structure 120,220 for a battery pack and a propulsion module for a powered watercraft as also illustrated in FIG. 7. Compared to FIG. 7, the alignment assembly structure 120,220 is here shown in an upside-down view to illustrate details underneath the alignment assembly structure 120,220 in its assemble state being shown in a right-side up view in FIG. 7. Here, the alignment assembly structure 120,220 also comprises a first alignment part 221 and a second alignment part 222 detachably connected or affixed together. As is shown here, the first alignment part 221 comprises a third alignment feature 123 and the second alignment part 222 comprises a fourth alignment feature 124. The third alignment feature 123 and the fourth alignment feature 124 are engaged with each other, for example as a form of fastening means, such as the third alignment feature 123 including a plurality of screw holes provided in the first alignment part 221 and the fourth alignment feature 124 including a plurality of screw fasteners arranged to individually engage with said screw holes to positon and fixedly locate the first and second alignment parts 221,222 accurately relative to each other.

The second alignment feature 122 is shown with a second abutment surface 132 forming a rear longitudinal channel 166. The rear longitudinal channel 166 extends in a longitudinal direction L to provide a space for receiving an elongated propulsion module, such as substantially prism- or cuboid-shaped jet drive having its greatest extent in the longitudinal direction L, i.e. being narrower transversally/vertically.

The rear longitudinal channel 166 may be shaped as an open-sided channel, such as extruded rigid chute, as for example shown here. The rear longitudinal channel 166 is configured to support and retain an elongated substantially prism- or cuboid-shaped propulsion module received at the second alignment feature 122. Further, the rear longitudinal channel 16 may be configured to provide substantial structural rigidity to counteract mechanical forces acting on a propulsion module received in the channel 166 during normal use. Preferably, a water inlet or duct portion of such a propulsion module is provide flush with or protruding from the open side of said channel 166 when mounted in the alignment assembly structure 120,220. The rear longitudinal channel 166 may have at least one open end portion, thus providing a geometrical shape compatible or configured to receive such a propulsion module. In this example, the alignment assembly structure 120,220 comprises an opening 126 provided between the first alignment part 221 and the second alignment part 222.

In this embodiment, the rear longitudinal channel 166 is configured to guide such a removable propulsion module into a detachable connection with a removable battery pack through the opening 126 by slideable engagement with said channel 166.

The third and fourth alignment features 123, 124 provide that the first alignment part 221 and the second alignment part 222 are accurately positioned and fixedly located relative to each other, such that the opening 126 provided between them likewise is accurately located in three-dimensional space relative to the assembly 120,220. It is advantageous that the opening 126 is accurately located in three-dimensional space relative to the assembly 120,220 because it provides that a removable battery pack received at the first alignment feature 121 may accurately engage with a propulsion module received at the second alignment feature 122 through the opening 126.

Although not shown here, as discussed in relation to FIG. 7 above, fastening means may be provided by the second alignment feature 121 and configured to removable attach such a propulsion module when mounted in the alignment structure 120,220. For example, the fastening means may be a releasable latch or locking mechanism providing that the propulsion module is kept in the rear longitudinal channel 166.

FIG. 9 is an illustration of an alignment assembly structure 120,220 for a battery pack and a propulsion module for a powered watercraft as illustrated in FIGS. 7-8 for an assembled state where the first and second alignment part had been connected. Compared to FIGS. 7-8, the alignment assembly structure 120,220 is here shown in an unassembled state, i.e. prior to connecting the first alignment part 221 and the second alignment part 222 of the alignment assembly structure 120,220.

The alignment assembly structure 120,220 is shown being assembled from a first alignment part 221 for a removable battery pack and a second alignment part 222 for a removable propulsion module for a jetboard. In an unassembled state, as is shown here, the first alignment part 221 provides a third alignment feature 123 in a position to engage a fourth alignment feature 124 provide by the second alignment part 222 so as to precisely position and fixedly locate the first and second alignment parts 221,222 relative to each other by connecting said alignment features 123, 124. Hereby, a battery pack received at the first alignment feature 121, optionally kept in position within a battery cradle 146 by fastening means 180, is connectable through an opening 126 provided between the alignment parts 221,222 to deliver electrical power to a propulsion module received at the second alignment feature 122.

The alignment assembly structure 120,220 may be assembled into a substantially rigid support frame for a battery pack and electrical propulsion means for propelling a power watercraft, such as an electrically powered water-jet propelled surfboard. The support frame may be made of a heat-conducting material, such as metal, such as aluminum or steel, which provides that excess heat can be efficiently dispersed.

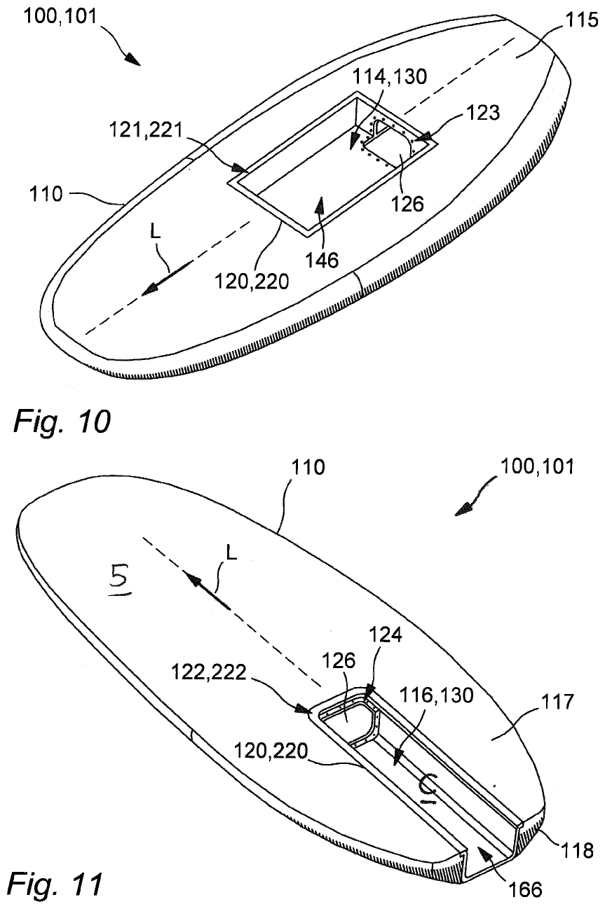

FIG. 10 is an illustration of another embodiment of a floatation body 110 having a cavity for housing electrical propulsion means for a powered watercraft 100, such as water-jet propelled surfboard 101, such as a hull or substantially rigid main body of a jetboard 100,101. An alignment structure 120,220 is shown installed in said cavity in the floatation body to form an upper compartment 114 providing an interior volume of space 130 within said floatation body 110 for housing a removable battery pack.

The alignment structure 120,220 is shown in an embodiment similar to the alignment assembly structure 120,220 illustrated in FIG. 7, where a first alignment feature 121 of the alignment structure 120,220 forms a battery cradle 146. It is here envisioned that an alignment assembly structure 120,220 comprising a first alignment part 221 may be installed by inserting the first alignment part 221 into one end portion of said cavity so that the first alignment part 221 is substantially flush with an upper surface 115 of the floatation body 110. For example, the first alignment part 221 illustrated in FIG. 8 may be inserted through an opening 126 in the upper surface 115 before the first alignment part 221 is connected to a second alignment part for said alignment assembly structure 120,220 or while the alignment assembly structure 120,220 is in an unassembled state. This may provide for easier installation into the body 110 by means of a third alignment feature 123 being positioned near the opening 126.

As a result, the alignment structure 120,220 may be installed within a cavity in the floatation body 110 so that an upper compartment 114 is formed in part of the cavity between the first alignment feature 121 and an upper surface 115 of the floatation body 110. Hereby, an accessible space is provided for a removable battery pack.

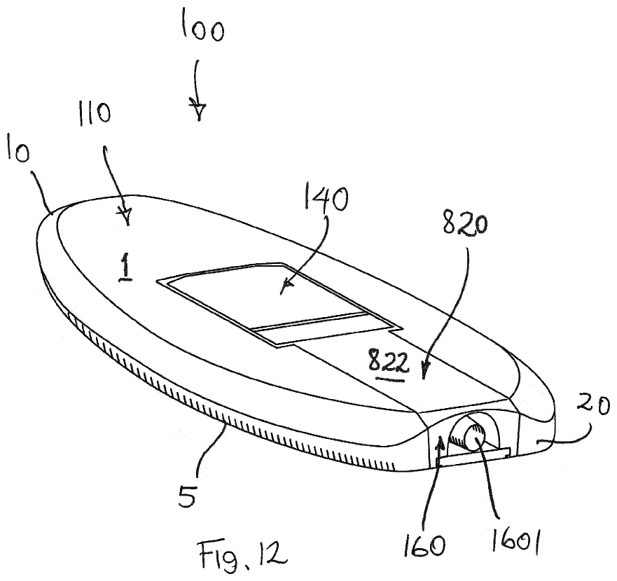

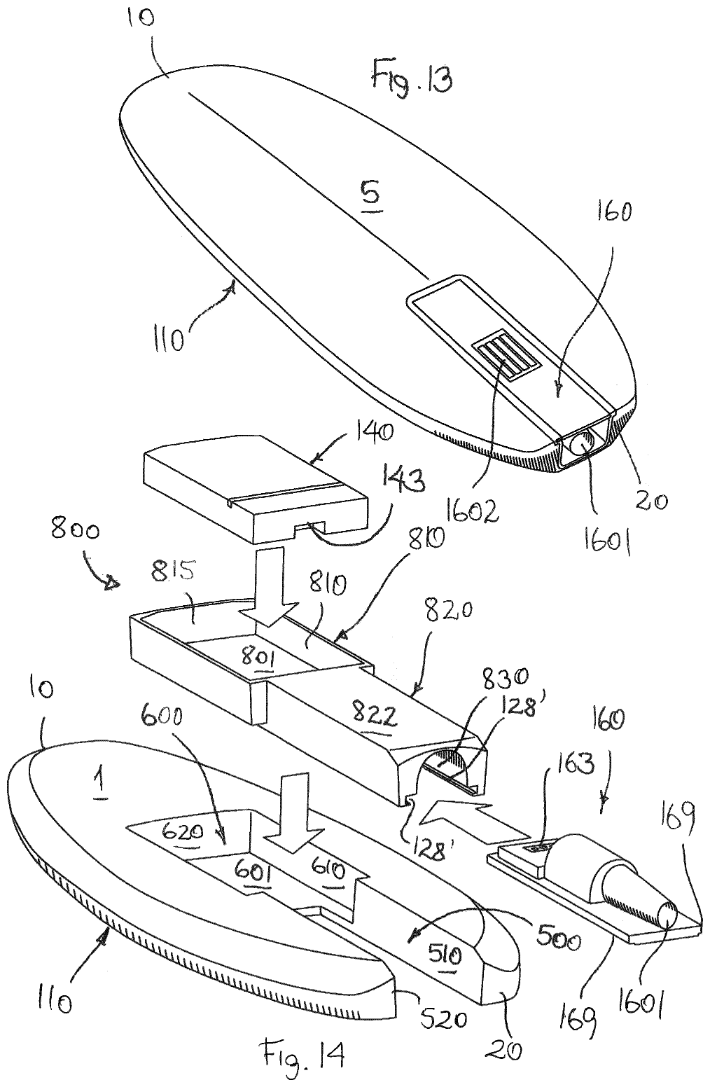

FIG. 11 is an illustration of an floatation body 110 having an elongated cavity for housing electrical propulsion means for a powered watercraft 100, such as water-jet propelled surfboard 101, as also illustrated in FIGS. 3 and 10. Compared to FIG. 10, the floatation body 110 is here shown in an upside-down view to illustrate details underneath the floatation body 110 being shown in a right-side up view in FIG. 10. An alignment structure 120,220 is shown installed in said elongated cavity in the floatation body to form a lower compartment 116 providing an interior volume of space 130 within said floatation body 110 for furthermore housing a removable propulsion module for propelling the powered watercraft 100.

The alignment structure 120,220 is shown in an embodiment similar to the alignment assembly structure 120,220 illustrated in FIG. 8, wherein a second alignment feature 122 of the alignment structure 120,220 forms a rear longitudinal channel 166. It is here envisioned that an alignment assembly structure 120,220 comprising a second alignment part 222 may be installed by inserting the second alignment part 222 into another end portion of said elongated cavity so that the second alignment part 222 is substantially flush with one or both of a lower surface 117 and a rear surface 118 of the floatation body 110. For example, the second alignment part 222 illustrated in FIG. 9 may be inserted through an opening 126 in the lower surface 117 before the second alignment part 222 is connected to a first alignment part for said alignment assembly structure 120,220 or while the alignment assembly structure 120,220 is in an unassembled state. This may provide for easier installation into the body 110 by means of a fourth alignment feature 124 being positioned near the opening 126.

Comparing illustrations of the alignment assembly structure 120,220 in FIGS. 9-11 in an unassembled state outside of the floatation body 110, i.e. in FIG. 9, with the first and second alignment parts 221,222 being mounted within a cavity in the floatation body 110 to form upper and lower compartments 114, 116 respectively, it should be apparent that an alignment assembly structure 120,220 comprising a first alignment part 221 and a second alignment part 222 are connectable through an opening 126 between the upper and lower compartments 114, 116 in the floatation body 110 such that the alignment assembly structure 120,220 is installed in its assembled state. It is advantageous that the alignment assembly structure 120,220 allows the first and second alignment part 221,221 to be installed separately from different end portions of the elongated cavity in the floatation body 110 because the elongated cavity can be designed for a tighter fit with the alignment assembly structure 120,220 without obstructing or complicating installation/removal of any of the constituent parts.

Accordingly, an alignment structure 120, 220 according to an embodiment of the present disclosure may allow for cheaper or less complicated designs and faster manufacturing of electrically powered watercraft 100, such as a water-jet propelled surfboard 101, by providing an improved method of securing a removable battery pack and a removable propulsion module within a cavity in the floatation body 110. The improved method may include positioning the alignment structure 120; 220 in the cavity so that the first and second alignment features provide compartments within said cavity for positioning and fixedly locating a removable battery pack and a removable propulsion module relative to each other such that they are individually removable. By securing the alignment structure 120,220 to the floatation body 110, the alignment structure 120,220 may in turn provide that the removable battery pack and the removable propulsion module relative are secured to the watercraft 100 and precisely position by means of the first and second alignment features, such that the alignment problem is safely and reliably solved for these removable components.

FIG. 12 shows an alternative watercraft 100 according to the first aspect of the invention, comprising the flotation body 110 shown in the exploded view of FIG. 14. The flotation body 110 may be formed of a foamed material and has a rear end 20 from which extends an elongated recess 500 which is defined by two opposite sides 510, 520 and which is upwardly and downwardly open. An upwardly open cavity 600 communicating along one side with the recess 500 is formed in the midportion of the flotation body 110, and is delimited by a bottom 601, which preferably defines on its opposite side a portion of the bottom face 5 of the flotation body 110, and by two pairs 610, 620 of opposite sides walls.

Within the cavity 600 and the recess 500 is secured a housing 800 in the form of a box-like, rigid or substantially rigid structure comprising a first housing part 810 and a second housing part 820. The first housing part 810 matches in size the cavity 600 and is upwardly open for receiving a battery pack 140 at the top face 1 of the flotation body 110. The first housing part 810 has two pairs 810, 815 of opposite side walls and preferably has on one or more of the side walls 810, 815 a releasable lock (not shown) similar to the lock 180 illustrated in FIG. 7, to keep the battery pack 140 in position in the first housing part 810.

The second housing part 820 matches in width and heights the recess 500 and defines a downwardly and rearwardly open channel C, see FIG. 16a. A top face 822 of the second housing part 820 defines an upper surface of the watercraft 100 on which a user 170 stands when using the watercraft 100; alternatively, the flotation body 110 may be provided with a skin covering the second housing part 820. As may be understood the top face 822 of the second housing part 820 is contiguous or essentially contiguous with the top face 1 of the flotation body 110 to provide a contiguous standing surface for the user 170, defined by the top face 1 of the flotation body 820, the top face 822 of the second housing part 820 and the top face of the battery pack 140, as seen best in FIG. 12.

The two housing parts 810, 820 communicate with each other via a passage or opening 126 similar to the opening 126 shown in FIG. 7 and formed at the end of the channel C in one side wall of one pair 815 of the two opposite sidewalls of the first housing part 810.

In one embodiment the flotation body 110 and the housing 800 of FIG. 12 are assembled by positioning the housing 800 in the cavity 600 and recess 500 following which a glued or similar connection is established; in another embodiment assembly may be by molding the flotation body 110 around the housing 800, the latter serving as a mould core.

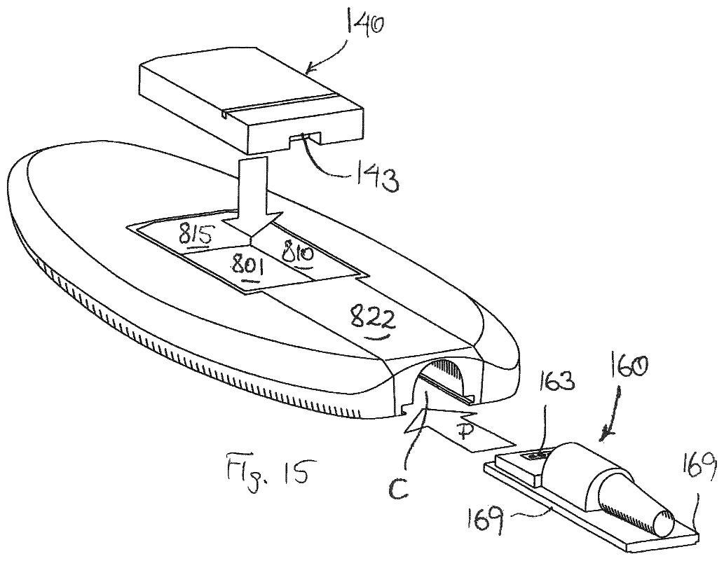

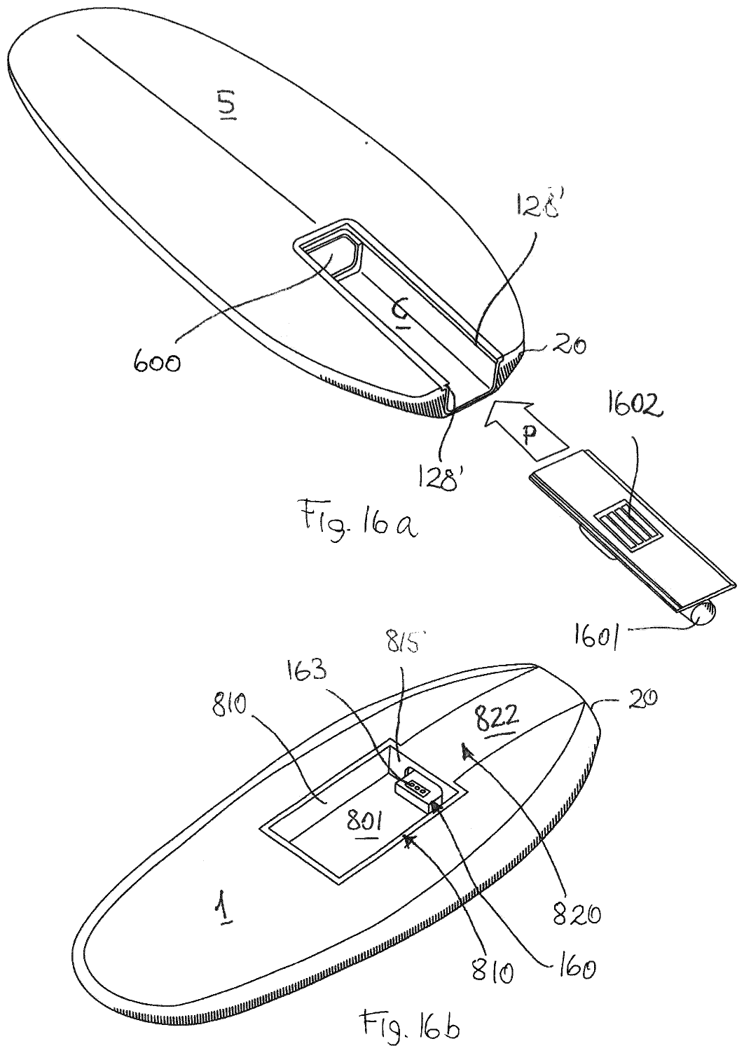

In the watercraft 100 of FIG. 12 a propulsion module 160 has been installed after the housing 800 and the flotation body 110 have been assembled. This installation is by moving, as shown in FIG. 16a, the propulsion module 160 along direction P into the channel C, at and from the rear end 20, along the length of the channel C and into an operative position shown in FIG. 13 wherein the propulsion module 160 may be powered by the battery pack 150 for propulsion of the watercraft 100.

FIGS. 13 and 16a show the propulsion module 160 water outlet 1601 and water inlet 1602. The propulsion module 160 comprises a drive which is energized by the battery pack 140 being connected with the propulsion module 160 via the aforementioned passage or opening between the first housing part 810 and the second housing part 820, which passage/opening is sized to permit an electrical contact 163 of the propulsion module 160 to extend in a water tight manner by seals (not shown) into the first housing part 810, to engage in a water-tight manner an electrical contact 142 of the battery pack 140, when the battery pack 140 has been inserted in the first housing part 810. The electrical contact 163 of the propulsion module 160 is shown in FIG. 16b, being presented to the battery pack 140 for electrical connection. Electrical connection is preferably established as a direct, cable-less connection between the electrical contacts 142, 163 as the battery pack 140 is moved into the first housing part 800 in a direction perpendicular to the bottom 801, to rest against the bottom 801; alternatively, direct electrical connection may be established by moving the battery pack 140 within the first housing part 810, or the propulsion module 160, along the longitudinal direction L of the watercraft 100.

Preferably, the elongated portion of the second housing part 810 defining the inside of the channel C has tracks and/or ribs 128′, which tracks and/or ribs 128′ are complementary with tracks and/or ribs 169 arranged along the length of the propulsion module 160, for supporting the propulsion module 160 in its operative position and providing a guiding and aligning function when the propulsion module 160 is installed. A lock is provided for releasably locking the propulsion module 160 in its operative position.

While the present disclosure has been described in detail in connection with only a limited number of embodiments or aspects, it should be readily understood that the present disclosure is not limited to such disclosed embodiments or aspects. Rather, the aspects of the present disclosure can be modified to incorporate any number of variations, alterations, substitutions or equivalent concepts not heretofore described, but which are commensurate in scope with the present disclosure. Additionally or alternatively, while various embodiments or aspects of the present disclosure have been described, it is to be understood that aspects of the present disclosure may include only some of the described embodiments or aspects or combinations of the various embodiments or aspects. Accordingly, the present disclosure is not to be seen as limited by the foregoing description.

### REFERENCES

100 Powered watercraft
101 Water-jet propelled surfboard
102 Electrical propulsion system
110 Floatation body
112, 600 Elongated cavity
114 Upper compartment
115 Upper surface
116, 500 Lower compartment
117 Lower surface
118 Rear surface
120, 800 Alignment structure
121 First alignment feature
122 Second alignment feature
123 Third alignment feature
124 Fourth alignment feature
126 Opening
128 Guide rail
130 Space
131 First abutment surface
132 Second abutment surface
140 Battery pack
141 Battery pack outer surface
142 Battery pack mounted position
143 Battery pack contact
144 Rechargeable battery cell
146 Battery cradle
150 Contacting portion
152 Electrical contact
153 Auxiliary electrical contact
160 Propulsion module
161 Propulsion module outer surface
162 Propulsion module mounted position
163 Propulsion module contact
164 Electronic circuit
165 Electrical motor
166 Rear longitudinal channel
168 Impeller
170 User
172 Controller
180 Fastening element
190 Fins
220 Alignment assembly structure
221, 810 First alignment part
222, 820 Second alignment part
d Distance
h Height
L Longitudinal direction
T Transversal direction
V Vertical direction
X First direction
Y Second direction

1. A watercraft comprising:
a flotation body comprising:
a top face providing a surface for a user to stand on when using a watercraft;
an opposite bottom face;
a front end;
a rear end;
a cavity opening up at the top face; and
a recess opening up at the bottom face, the recess extending from the rear end to the cavity;
a housing connected to the flotation body, the housing comprising a first housing part connected to a second housing part;
wherein:
the first housing part being positioned in the cavity and being upwardly open for receiving a battery pack at the top face;
the battery pack being for powering a propulsion unit for propulsion of the watercraft;
the second housing part being positioned in the recess and defining a downwardly and rearwardly open channel of the watercraft;
the open channel being configured for receiving the propulsion module by moving the propulsion module in a direction into the open channel at the rear end and along a length of the open channel, into an operative position wherein the propulsion module may be powered by the battery pack for propulsion of the watercraft.

2. The powered watercraft of claim 1, wherein a top face of the second housing part provides a surface for the user to stand on when using the watercraft, or wherein a top face of the second housing part is covered by a skin for the user to stand on when using the watercraft.

3. The powered watercraft according to claim 1, the open channel comprising tracks and/or ribs along the length of the open channel, for supporting the propulsion module in the operative position.

4. The powered watercraft according to claim 1, comprising a lock for locking the propulsion module in the operative position.

5. The powered watercraft according to claim 1, the flotation body being molded around parts of the housing to establish a connection between the flotation body and the housing.

6. The powered watercraft according to claim 1, the first housing part being integrally connected with the second housing part, and/or wherein an opening between the first housing part and the second housing part permits an electrical contact of the propulsion module to engage an electrical contact of the battery pack, when the battery pack is placed in the cavity when the propulsion module is in the operative position.

7. An alignment structure for a battery pack and a propulsion module for a powered watercraft, wherein the alignment structure is configured to be received in and affixed to the powered watercraft, the alignment structure comprising:
a first alignment feature configured to receive a removable battery pack; and
a second alignment feature configured to receive a removable propulsion module for propelling the powered watercraft in a longitudinal direction;
wherein the alignment structure extends along the longitudinal direction to provide a space for the battery pack and/or the propulsion module; and
wherein the first alignment feature and the second alignment feature are configured for positioning and fixedly locating the battery pack and the propulsion module relative to each other so that the battery pack and the propulsion module are individually removable.

8. The alignment structure according to claim 7, wherein the first alignment feature and the second alignment feature overlap a first distance as seen along the longitudinal direction and/or are spaced a second distance apart as seen along a vertical axis perpendicular to the longitudinal direction.

9. The alignment structure according to claim 7, wherein the first alignment feature includes an opening having substantially smooth sides for slidably receiving the battery pack; and/or a channel comprising two or more parallel guide rails extending along the longitudinal direction and spaced apart from each other.

10. The alignment structure according to claim 7, wherein the alignment structure provides a mechanical interface for aligning a first contacting portion of the battery pack with a second contacting portion of the propulsion module to connect electrical contacts provided at the first contacting portion and the second contacting portion with each other.

11. The alignment structure according to claim 7, wherein the alignment structure is a substantially rigid support frame made of a heat-conducting material.

12. The alignment structure according to claim 7, wherein the first alignment feature forms a battery cradle configured to support and retain the battery pack against a force of gravity when in a mounted position.

13. The alignment structure according to claim 7, wherein the second alignment feature forms a rear longitudinal channel configured to guide the propulsion module into detachable connection with the battery pack in a mounted position by slidable engagement with the rear longitudinal channel.

14. The alignment structure according to claim 7, wherein the alignment structure is an alignment assembly structure comprising:
a first alignment part and a second alignment part, the first alignment part comprising the first alignment feature and a third alignment feature, the second alignment part comprising the second alignment feature and a fourth alignment feature; and
wherein the third alignment feature and the fourth alignment feature are configured for positioning and fixedly locating the first alignment part and the second alignment part relative to each other.

15. A method of securing a removable battery and a removable propulsion module within a watercraft body for a powered watercraft, the method comprising:
providing a watercraft body of a powered watercraft, wherein the watercraft body extends in a longitudinal direction and having a cavity;
providing an alignment structure comprising a first alignment feature (121) configured to receive a removable battery pack and a second alignment feature configured to receive a removable propulsion module for propelling the powered watercraft in the longitudinal direction;
positioning the alignment structure in the cavity so that the first alignment feature and the second alignment feature provide a for positioning and fixedly locating the removable battery pack and the removable propulsion module relative to each other so that the removable battery pack and the removable propulsion module are individually removable; and
securing the alignment structure to the watercraft body.
